(19) United States
(12) Patent Application Publication
(10) Pub. No.: US 2025/0240364 A1
(43) Pub. Date: Jul. 24, 2025

(54) ADJUSTABLE MOBILE DEVICE HOLDER

(71) Applicants: Jeffrey D. Hancock, Ogden, UT (US); Christopher N. Schenck, Ogden, UT (US); Jeffrey McKade Hancock, Ogden, UT (US)

(72) Inventors: Jeffrey D. Hancock, Ogden, UT (US); Christopher N. Schenck, Ogden, UT (US); Jeffrey McKade Hancock, Ogden, UT (US)

(21) Appl. No.: 19/034,416

(22) Filed: Jan. 22, 2025

Related U.S. Application Data
(60) Provisional application No. 63/623,751, filed on Jan. 22, 2024.

(51) Int. Cl. H04M 1/04; F16M 11/14; F16M 13/02

(52) U.S. Cl. CPC H04M 1/04; F16M 11/14; F16M 13/022; F16M 2200/022

(57) ABSTRACT

An adjustable device holder may include a first cradle portion coupled to a second cradle portion. A connector, such as a threaded rod, may be partially disposed within a first slot in the first cradle portion and a second slot in the second cradle portion. A fastener and a spring may be at least partially disposed in the second slot. A cradle adjustment knob may be coupled to the threaded rod such that rotation of the cradle adjustment knob in one direction may thread the threaded rod into the threaded fastener and rotation of the cradle adjustment knob in an opposite direction may thread the threaded rod out of the threaded fastener. The cradle adjustment knob may tighten the cradle portions against the device or spread the cradle portions apart. The spring may exert a force as the cradle portions are tightened against the device.

### CROSS-REFERENCE TO RELATED APPLICATIONS

This patent application claims priority to and the benefit of U.S. Provisional Patent Application Ser. No. 63/623,751, entitled MAGNETIC CONNECTORS, filed Jan. 22, 2024, which is incorporated by reference in its entirety.

### FIELD

The present disclosure generally relates to an adjustable mobile device holder for a mobile device.

### BACKGROUND

Individuals often desire mobile devices, such as a cellular telephone or mobile phone, to be nearby and conveniently located during various activities. For example, a mobile device holder may be positioned so that a mobile phone is easy to access and view when driving a vehicle. The mobile device holders may allow users to view the display without having to physically hold the device.

Conventional mobile device holders may utilize holding arms to secure the mobile device within a cradle. The holding arms may be adjustable such that the cradle may accommodate mobile devices of assorted sizes. Some cradles utilize a spring to adjust the width of the cradle and to provide a force to secure the mobile device within the cradle. In these cradles, the individual may place the mobile device in the cradle, which may activate the spring. The activation of the spring creates a force that causes the holding arms to secure the mobile device in a fixed position. The force exerted by the spring may be dependent on the width of the mobile device. The force exerted by the spring may be larger if the mobile device has a larger width and the force exerted by the spring may be smaller if the mobile device has a smaller width. To remove the mobile device, the individual often manually pulls the holding arms apart, which may further activate the spring. Thus, in many conventional mobile device holders, the spring serves a width adjustment function and a securement function, but the amount of force the spring provides to secure the mobile device is dependent on the size of the mobile device.

Other known mobile device holders may utilize an adjustment knob to manually adjust the width such that the mobile device may be secured within the cradle. For example, the mobile device may be placed within the holding arms, and the adjustment knob may be manipulated to tighten the holding arms against the mobile device. To remove the mobile device, the adjustment knob may be manipulated to spread the holding arms apart. A spring may also be utilized in these cradles to spread the holding arms apart without manipulating the adjustment knob. This may allow the mobile device to be removed without altering the desired width of the cradle. The spring, however, is only activated when the holding arms are spread apart to remove the mobile device, and the spring does not exert a force while the mobile device is secured within the cradle.

The claimed subject matter is not necessarily limited to embodiments that solve any disadvantages or that operate only in environments such as those described above. Rather, this background is only provided to illustrate one example technology area where some disclosed embodiments described may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Conventional mobile device holders often include cradles and some known mobile device holders utilize springs for adjusting the width of the cradle, and, in some cases, the springs may also provide a force that secures the mobile device within the cradle. Because the springs are utilized for width adjustment, the spring force provided (if any) is dependent on the width of the mobile device. Thus, the larger the mobile device, the more spring force exerted. On the other hand, the smaller the mobile device, the less spring force exerted. Because the spring force is dependent on the size of the mobile device, larger mobile devices may be secured in the cradle too tightly, and smaller mobile devices may be secured in the cradle too loosely. Disadvantageously, larger mobile devices may be difficult to insert and remove from conventional mobile device holders because of the spring force, and smaller mobile devices may not be securely held within the holder. Additionally, a large and sometime excessive force may be applied to the spring for larger phones, and that may decrease the life of the spring.

In other known mobile device holders, a spring may be used to allow the holding or cradle arms to be outwardly adjusted such that the mobile device may be removed. The spring in these known mobile device holders, however, does not provide a force that is translated to the holding arms to secure the mobile device in the cradle. Thus, the spring serves merely a width adjustment function and not a securement function.

Accordingly, there is a need for an improved mobile device holder that decouples the spring from the width adjustment of the cradle while also providing an adjustable spring force such that the mobile device may be secured appropriately regardless of the size of the mobile device.

Advantageously, exemplary embodiments of the disclosed adjustable mobile device holder may address the problems in traditional mobile device holders, such as those associated with spring forces being dependent on the size of the mobile device or those associated with the spring only being used for width adjustment and not being utilized to secure the mobile device. Exemplary embodiments of the disclosed adjustable mobile device holder may address these issues by providing one or more features such as a first cradle portion coupled to a second cradle portion. The cradle portions may form at least a portion of a cradle capable of receiving a mobile device. A connector, such as a threaded rod, may be at least partially disposed within a first slot in the first cradle portion and at least partially disposed within a second slot in the second cradle portion. The threaded rod may couple, at least in part, the first cradle portion and the second cradle portion. A threaded fastener may be disposed in the second slot of the second cradle portion, and a cradle adjustment knob may be coupled to the threaded rod such that rotation of the cradle adjustment knob in one direction may cause the threaded rod to advance within the second slot and thread into the threaded fastener and rotation of the cradle adjustment knob in an opposite direction may cause the threaded rod to retreat within the second slot and thread out of the threaded fastener. A spring may be disposed in the second slot of the second cradle portion, and the spring may be sized and configured to exert a force as the first cradle portion and the second cradle portion are tightened against the mobile device via the cradle adjustment knob. Thus, in this exemplary embodiment, the cradle adjustment knob may adjust the width of the cradle to secure the mobile device within the mobile device holder, and the spring may exert a force as the width is adjusted by the adjustment knob to further secure the phone.

In some embodiments, the threaded fastener may be mobile or movable. For instance, the threaded fastener may be movable within the second slot. The threaded fastener may be configured to move toward the first cradle portion as the cradle is decreased in size and the spring may be compressed. The threaded fastener may be configured to move away from the first cradle portion as the cradle is increased in size and the spring may be at least partially decompressed. In an example embodiment, the threaded fastener may be disposed within an enlarged portion of the second slot, and the threaded fastener may be movable within the enlarged portion of the second slot. The enlarged portion of the second slot may help control movement of the threaded fastener. For instance, one end of the enlarged portion of the second slot may limit movement of the threaded fastener in one direction and the other end of the second slot may limit movement of the threaded fastener in another direction. The spring may at least partially be disposed in the enlarged portion of the second slot, and the enlarged portion of the second slot may help position the spring. For example, an end of the spring may engage an end of the enlarged portion of the second slot.

In some embodiments, the threaded fastener may be configured to move within the second slot toward the first cradle portion as pressure is applied to a mobile device placed within the cradle, and the movement of the threaded fastener toward the first cradle portion may compress the spring. The threaded fastener may be configured to move away from the first cradle portion as pressure is at least partially released from the mobile device placed within the cradle, and the movement of the threaded fastener away from the first cradle portion may cause the spring to at least partially decompress.

In some embodiments, the adjustable mobile device holder may include a cam-lock, and the cam-lock may be coupled to the threaded rod. The cam-lock may be configured to at least maintain the force exerted by the spring when engaged and to reduce the force exerted by the spring when disengaged. In some of these embodiments, the cam-lock may include a cam lever, and the cam-lock may be engaged and/or disengaged via the cam lever.

In some embodiments, the first cradle portion and the second cradle portion may include one or more holding arms, and the one or more holding arms may form at least a portion of the cradle. The holding arms may be sized and configured to hold the mobile device in a fixed position. In some embodiments, the first cradle portion and the second cradle portion may each include an upper holding arm and a lower holding arm. In this exemplary embodiment, the upper holding arm of the first cradle portion may be sized and configured to engage one side of the mobile device, the upper holding arm of the second cradle portion may be sized and configured to engage an opposite side of the mobile device, and the lower holding arms may be sized and configured to engage a bottom portion of the mobile device. In some embodiments, the first cradle portion and the second cradle portion may each include two upper holding arms and a lower holding arm. In this exemplary embodiment, the upper holding arms of the first cradle portion may be sized and configured to engage one side of the mobile device, the upper holding arms of the second cradle portion may be sized and configured to engage an opposite side of the mobile device, and the lower holding arms may be sized and configured to engage a bottom portion of the mobile device.

In some embodiments, an inner portion, such as a wall, of at least one of the holding arms may be configured to engage the mobile device at a first engagement point and a second engagement point. A space may be disposed between the first engagement point and the second engagement point. A space may also be disposed between at least a portion of the inner wall and the first engagement point and the second engagement point. In these and other embodiments, the inner wall of the at least one holding arm may be at least substantially or partially V-shaped, and the inner wall of the at least one holding arm may have a rounded vertex. In some embodiments, at least one of the one or more holding arms may include a set of one or more protrusions extending from an inner wall of the at least one holding arm, and the set of protrusions may be sized and configured to frictionally grip the mobile device within the cradle.

In some embodiments, the adjustable mobile device holder may include a device mount, and the device mount may be coupled to at least one of the first cradle portion or the second cradle portion. In these exemplary embodiments, the device mount may include a mount base, and the mount base may be sized and configured to couple the device mount to a support surface, a mounting arm coupled to the mount base, a mounting interface coupled to the mounting arm and coupled to at least one of the first cradle portion or the second cradle portion, and the like. In some embodiments, the device mount may include a mount adjustment knob coupled to the mounting interface, and the mount adjustment knob may tighten the mounting interface between the mounting arm and at least the first cradle portion and/or the second cradle portion when rotated in one direction and loosen the mounting interface between the mounting arm and at least the first cradle portion and/or the second cradle portion when rotated in an opposite direction. In some embodiments, the device mount may include a mount adjustment knob coupled to the mounting base, and the mount adjustment knob may tighten the mounting arm to the mounting base when rotated in one direction and loosen the mounting arm when rotated in an opposite direction.

In some embodiments, the mounting interface may be a ball and socket joint. In some embodiments, the device mount may be coupled to a support surface or support structure, which may be part of a vehicle.

In some embodiments, the first cradle portion and/or the second cradle portion may include one or more tabs, and the first cradle portion and/or the second cradle portion may include one or more recesses. In some of these embodiments, each tab extending from one of the cradle portions may be sized and configured to fit in a recess in a different cradle portion. In some embodiments, the tabs may be rods, and the recesses may be openings having a shape and size to receive the rods. In some embodiments, a first rod may extend from one of the first cradle portion or the second cradle portion into a first recess in the other cradle portion, and a second rod may extend from one of the first cradle portion or the second cradle portion into a second recess in the other cradle portion. In some embodiments, the one or more tabs may be protrusions or outwardly extending portions, and the one or more recesses may be openings or receiving portions. The receiving portions may have a shape, size, configuration, and/or arrangement to receive the protrusions.

In some embodiments, the spring may be disposed in the second slot forward of the threaded fastener such that the spring is closer to the first cradle portion than the fastener. In some embodiments, the threaded rod may run through or be at least partially disposed within the spring.

Advantageously, the exemplary embodiments may improve adjustable mobile device holders because the width of the cradle may be adjusted independently of the spring. Additionally, the spring force may be adjusted such a precise amount of spring force may be exerted irrespective of the size of the mobile device within the cradle.

The object and advantages of the embodiments may be realized and achieved at least in part by the elements, features, and combinations particularly pointed out in the claims. It is to be understood that both the foregoing general description and the following detailed description are explanatory and are not restrictive of the invention, as claimed.

These and other aspects, features, and advantages may become more fully apparent from the following brief description of the drawings, the drawings, the detailed description, and the claims.

### BRIEF DESCRIPTION OF THE DRAWINGS

The appended drawings contain figures of example embodiments to further illustrate and clarify the above and other aspects, advantages, and features of the present invention. It will be appreciated that these drawings depict only example embodiments of the invention and are not intended to limit its scope. Additionally, it will be appreciated that while the drawings may illustrate preferred sizes, scales, relationships and configurations of the invention, the drawings are not intended to limit the scope of the claimed invention, and the drawings are not necessarily to scale. Example embodiments will be described and explained with additional specificity and detail through the use of the accompanying drawings in which:

FIG. 1A is a perspective view of an example adjustable mobile device holder, illustrating an example mobile device secured within the adjustable mobile device holder;

FIG. 1B is a front perspective view of the example adjustable mobile device holder shown in FIG. 1A;

FIG. 1C a perspective view of the example adjustable mobile device holder shown in FIG. 1A without the example mobile device;

FIG. 1D is a top perspective view of the example adjustable mobile device holder shown in FIG. 1A;

FIG. 1E is an enlarged side perspective view of the holding arms of the example adjustable mobile device holder shown in FIG. 1A, illustrating the holding arms engaging an exemplary mobile device;

FIG. 1F is a front section view of the example adjustable mobile device holder shown in FIG. 1A;

FIG. 1G is an exploded view of the example adjustable mobile device holder shown in FIG. 1A;

FIG. 2 is a perspective view of another example adjustable mobile device holder, illustrating the holding arms with protrusions;

FIG. 3A is a perspective view of another example adjustable mobile device holder, illustrating a mobile device secured within the adjustable mobile device holder;

FIG. 3B is a perspective view of the example adjustable mobile device holder shown in FIG. 3A without the exemplary mobile device;

FIG. 3C is a front sectional view of the example adjustable mobile device holder shown in FIG. 3A;

FIG. 3D is an exploded view of the example adjustable mobile device holder shown in FIG. 3A;

FIG. 4A is a perspective view of another example adjustable mobile device holder, the adjustable mobile device holder including an example device mount;

FIG. 4B is an exploded view of the example adjustable mobile device holder shown in FIG. 4A;

FIG. 4C illustrates the example adjustable mobile device holder shown in FIG. 4A coupled to an example vehicle via an example device mount;

FIG. 5A is a perspective view of another example adjustable mobile device holder, the adjustable mobile device holder including another example device mount;

FIG. 5B is an exploded view of the example adjustable mobile device holder shown in FIG. 5A;

FIG. 6A is a perspective view of another example adjustable mobile device holder, the adjustable mobile device holder including another example device mount;

FIG. 6B is an enlarged perspective view of the adjustable mobile device holder shown in FIG. 6A;

FIG. 7 is a perspective view of another example adjustable mobile device holder, the adjustable device holding including another example device mount; and

FIG. 8 is a perspective view of another example adjustable mobile device holder, the adjustable device holder including another example device mount.

### DETAILED DESCRIPTION

The present disclosure is directed towards an adjustable mobile device holder that may receive, hold, and secure a mobile device such as a cellular phone or mobile phone. The present disclosure, however, is not limited to an adjustable mobile device holder that may be used to receive, hold, and/or secure a mobile device. It will be understood that, in light of the present disclosure, the adjustable mobile device holder may be successfully used to receive, hold, and secure other devices such as a tablet computer, laptop computer, GPS device, light, camera, recording device, speaker, and the like. While the adjustable mobile device may be described in connection with electronic devices, it will be understood that any suitable type of device may be used with the adjustable mobile device, and the device does not have to be electronic, and the device does not have to be mobile.

Furthermore, the present disclosure may generally describe exemplary embodiments of the adjustable mobile device holder as being coupled to a golf cart, an all-terrain vehicle (ATV), a utility-task vehicle, or other vehicles. It will be understood that, in light of the present disclosure, the adjustable mobile device holder may be successfully used in connection with other types of structures and devices, and these structures and devices may be movable or immovable. For example, the mobile device holder may be attached to a push cart or a golf bag.

Additionally, to assist in the description of the adjustable mobile device holder, words such as top, bottom, front, rear, right and left may be used to describe the accompanying figures. It will be appreciated, however, that the adjustable mobile device holder may be disposed in a variety of desired positions, including various angles, sideways, and even upside down. Further, the drawings may show the adjustable mobile device holder, along with various components, attachments, and accessories, to scale. The drawings, however, are not necessarily to scale and the adjustable mobile device holder may have other suitable shapes, sizes, configurations, and arrangements. Additionally, in the figures, features with the same reference numbers may indicate similar features, and these features may have similar structures and/or functions.

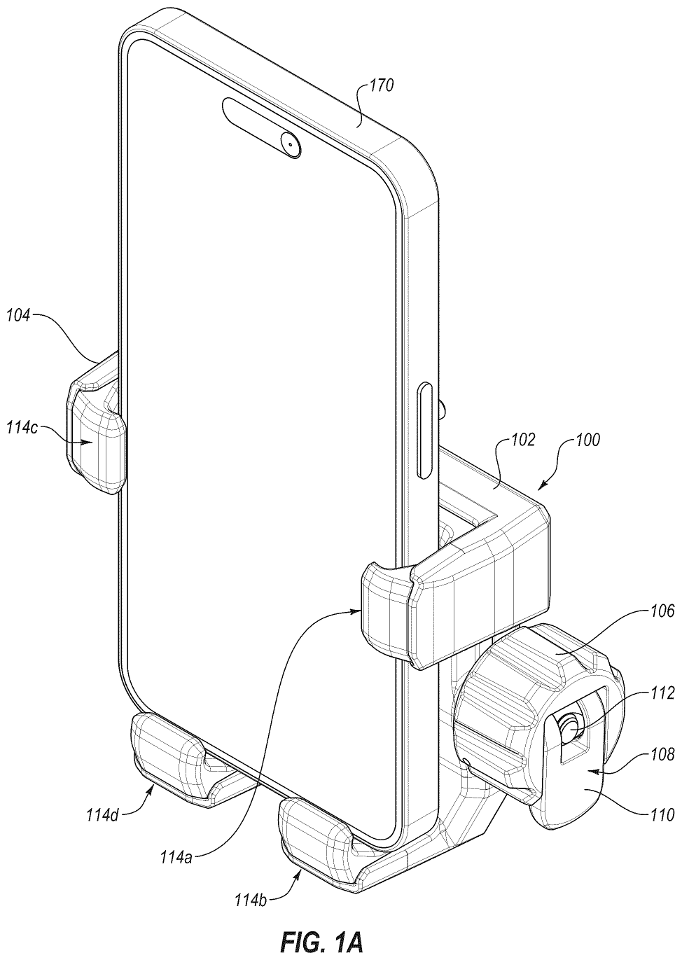

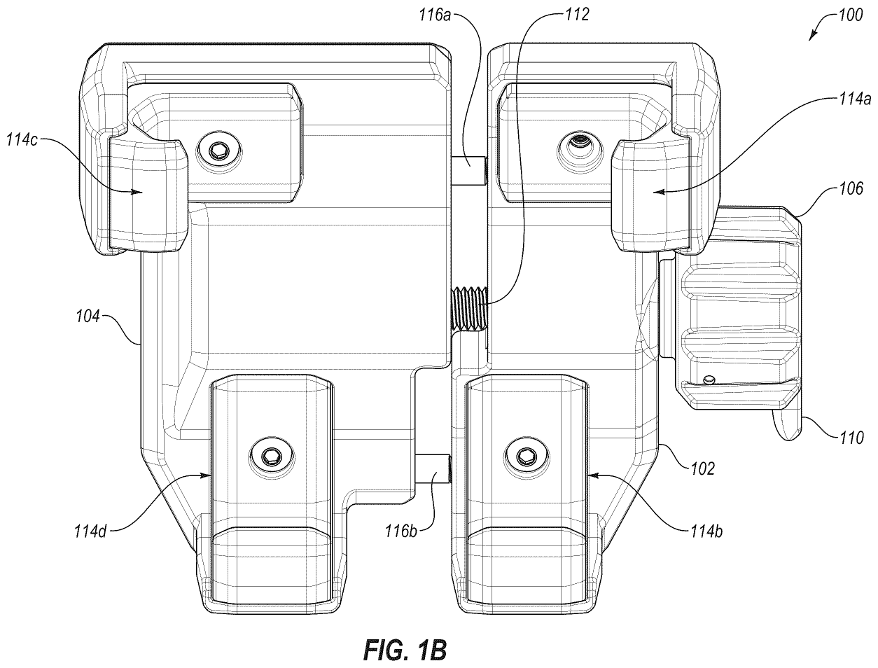

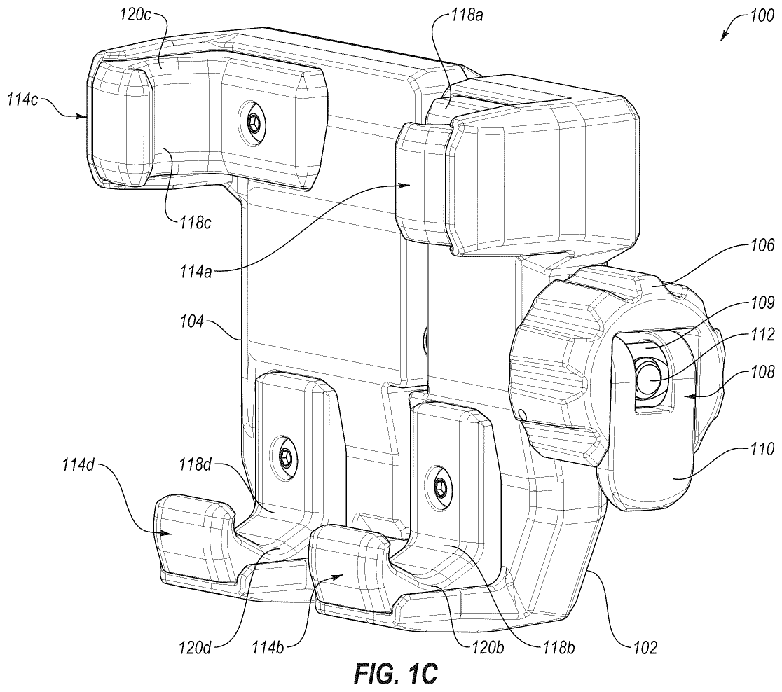

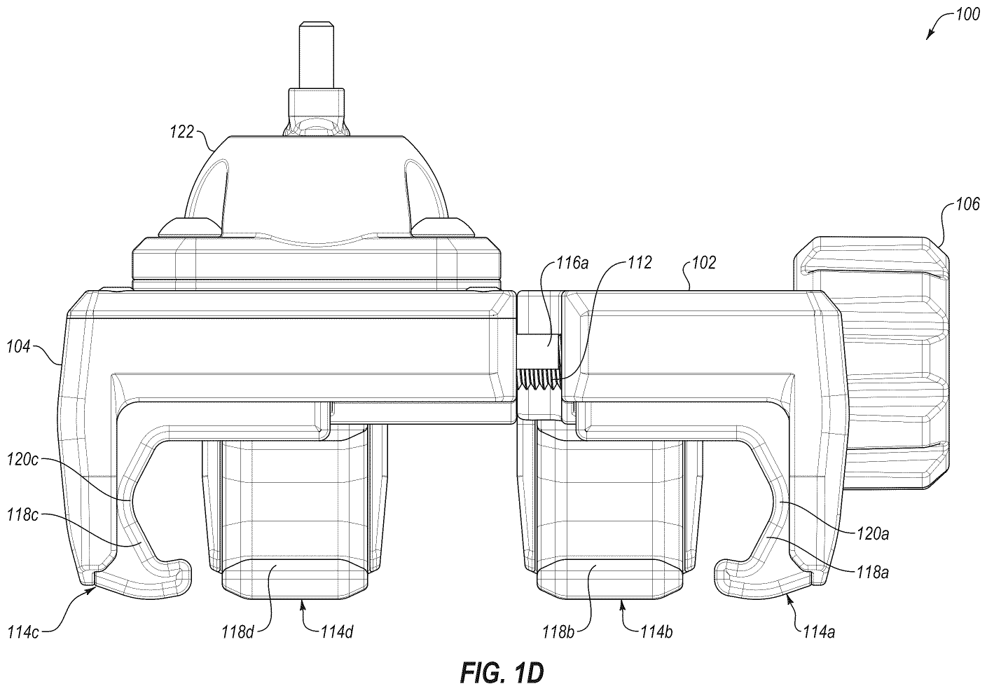

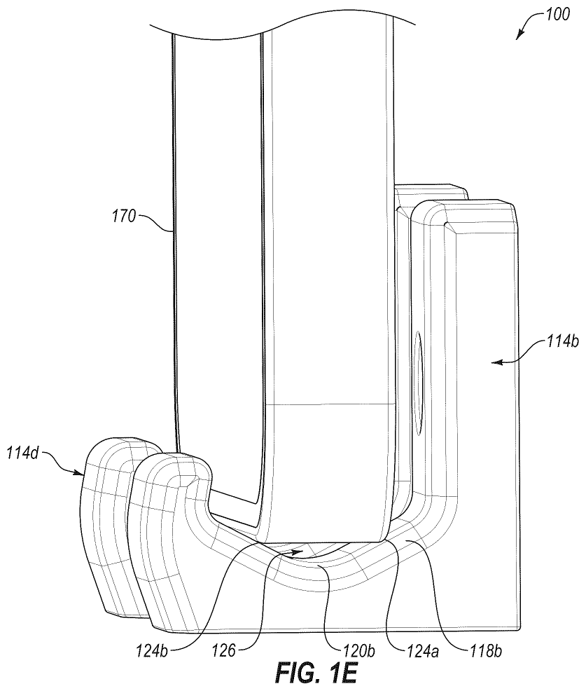

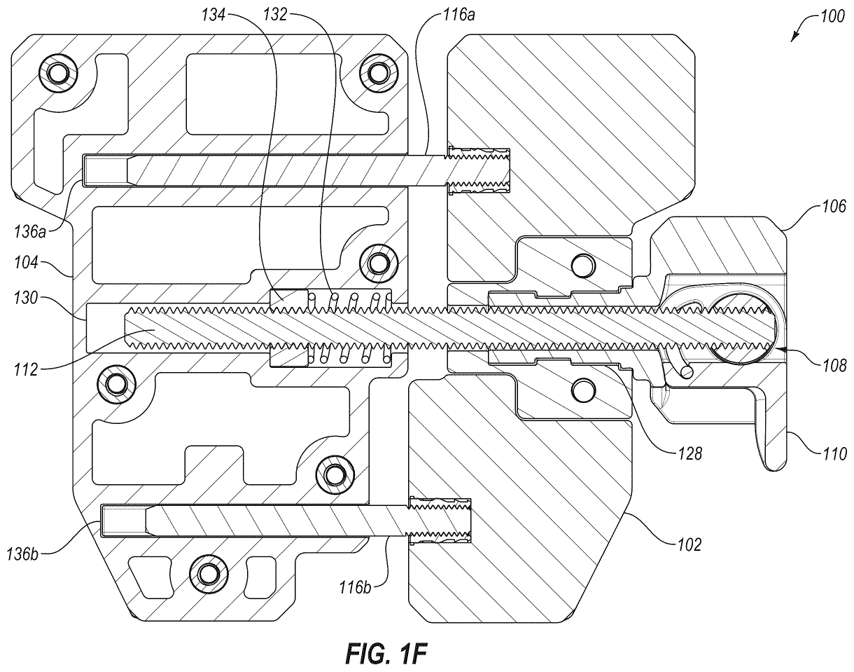

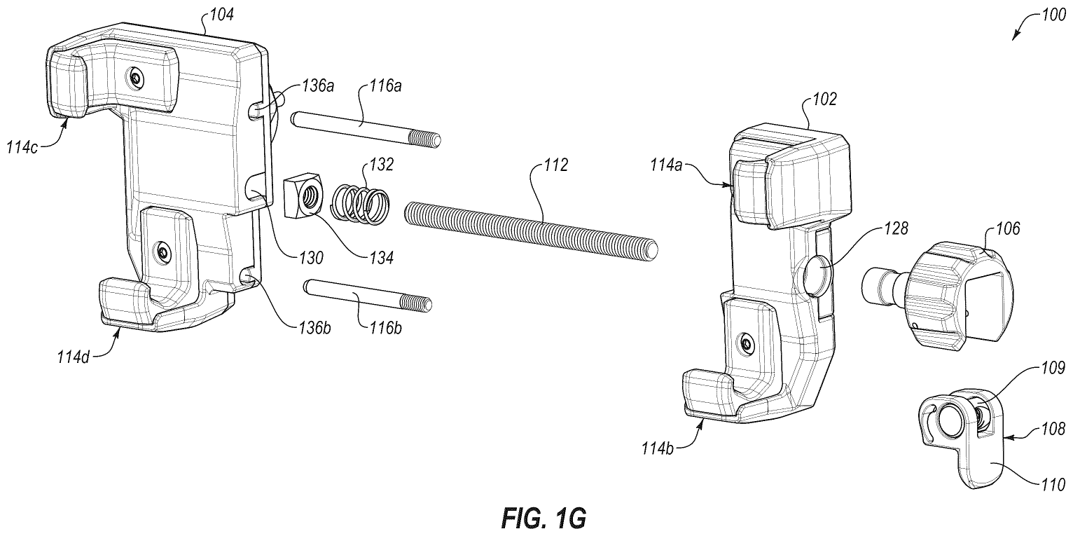

FIG. 1A illustrates an example adjustable mobile device holder 100 with a mobile device 170 secured within the example adjustable mobile device holder 100. As illustrated in FIG. 1A, the adjustable mobile device holder 100 may include a first cradle portion 102 and a second cradle portion 104 that may be coupled via a threaded rod 112. The first cradle portion 102 and the second cradle portion 104 may form at least a portion of a cradle, and the cradle may be sized and configured to receive the mobile device 170. In some embodiments, such as illustrated in FIG. 1A, the first cradle portion 102 and the second cradle portion 104 may include one or more holding arms 114. The holding arms 114 may form at least a portion of the cradle, and the holding arms may help hold the mobile device 170 in place. As illustrated in FIG. 1A, the first cradle portion 102 may include an upper holding arm 114a and a lower holding arm 114b, and the second cradle portion 104 may include an upper holding arm 114c and a lower holding arm 114d. (collectively the holding arms 114). The upper holding arm 114a may engage one side or portion of the mobile device 170, the upper holding arm 114c may engage an opposite side or portion of the mobile device 170, and the lower holding arms 114b and 114d may engage a bottom side or portion of the mobile device 170. The one or more holding arms 114 are explained in more detail with reference to FIGS. 1B-1D.

The threaded rod 112 may be partially disposed within a first slot (not shown) in the first cradle portion 102 and partially disposed within a second slot (not shown) in the second cradle portion 104. The threaded rod 112 is described in more detail with reference to FIGS. 1F-1G.

The adjustable mobile device holder 100 may include a threaded fastener (not shown) that may be disposed in the second slot and may receive the threaded rod 112. The threaded fastener is described in more detail with reference to FIGS. 1F-1G.

The adjustable mobile device holder 100 may include a cradle adjustment knob 106. The cradle adjustment knob 106 may be coupled to the threaded rod 112 such that rotation of the cradle adjustment knob 106 in one direction may cause the threaded rod 112 to advance within the second slot and thread into the threaded fastener. In some embodiments, rotation of the cradle adjustment knob 106 in an opposite direction may cause the threaded rod 112 to retreat within the second slot and thread out of the threaded fastener. In some embodiments, the cradle adjustment knob 106 may adjust the cradle by tightening the first cradle portion 102 and the second cradle portion 104 against the mobile device 170 (e.g., by moving the first cradle portion 102 and the second cradle portion 104 together or towards each other), or by spreading the first cradle portion 102 and the second cradle portion 104 apart (e.g., by by moving the first cradle portion 102 and the second cradle portion 104 apart or away from each other). In some embodiments, the cradle adjustment knob 106 may tighten the upper holding arms 114a and 114c against the mobile device 170 or spread the upper holding arms 114a and 114c apart. The cradle adjustment knob 106 is described in more detail with reference to FIGS. 1F-1G.

The adjustable mobile device holder 100 may include a spring (not shown), and the spring may be disposed in the second slot. The spring may exert a force as the first cradle portion 102 and the second cradle portion 104 are tightened against the mobile device 170 via the cradle adjustment knob 106. The spring is described in more detail with reference to FIGS. 1F-1G.

In some embodiments, the adjustable mobile device holder 100 may include a cam-lock 108. The cam-lock 108 may be coupled to the threaded rod 112 and may at least maintain the force exerted by the spring when engaged and reduce the force exerted by the spring when disengaged. In some embodiments, the cam-lock 108 may include a cam lever 110, which may engage and disengage the cam-lock 108. As illustrated in FIG. 1A, the cam lever 110 may be disposed in an engaged position, and the cam-lock 108 may be sized and configured to at least maintain the force generated by the spring. The cam-lock 108 is described in more detail with reference to FIGS. 1F-1G.

In an example operation of the adjustable mobile device holder 100, the mobile device 170 may be placed within the holding arms 114, which may form at least a portion of the cradle. A user may rotate the cradle adjustment knob 106 (e.g., in a clockwise direction) to advance the threaded rod 112 within the second slot and thread the threaded rod 112 into the threaded fastener. By rotating the cradle adjustment knob 106, for example in a clockwise direction, the cradle may be adjusted in that the first cradle portion 102 and the second cradle portion 104 may tighten against or contact the mobile device 170, which may secure the mobile device 170 in a fixed position. For example, rotating the cradle adjustment knob 106 may cause the threaded rod 112 to advance within the second slot and thread into the threaded fastener, which may cause the first cradle portion 102 to move closer to the second cradle portion 104 thereby tightening or contacting the upper holding arms 114a and 114c against the sides of the mobile device 170. As the cradle adjustment knob 106 tightens the first cradle portion 102 and the second cradle portion 104 against the mobile device 170 (e.g., the upper holding arms 114a and 114c), the spring may be activated and may exert a force, which may be translated to the upper holding arm 114a and 114c, and the force may help secure the mobile device 170 in a fixed position. For example, the threaded fastener may be mobile or movable within the second slot. As shown in the accompanying figures, the threaded fastener may be disposed within an enlarged portion of the second slot. The threaded fastener may be disposed within the second slot such that as the first cradle portion 102 and the second cradle portion 104 are tightened against the mobile device 170, pressure may be applied to the mobile device 170 that may be translated to the threaded rod 112 influencing the threaded rod 112 to move out of the second slot. Because the threaded rod 112 may be threaded into the threaded fastener, the threaded rod 112 may cause the threaded fastener to move within the second slot towards the first cradle portion 102 and the spring may be compressed.

The cradle adjustment knob 106 may continue to be rotated in the same direction to further tighten the first cradle portion 102 and the second cradle portion 104 against the mobile device 170 and the force exerted by the spring may increase. Thus, the user may modify how much spring force is exerted by utilizing the cradle adjustment knob 106. In some embodiments, the user may engage the cam-lock 108 with, for example, the cam lever 110. The cam-lock 108 may be used to at least maintain the amount of force exerted by the spring. In an example embodiment, the cam-lock 108 may be sized and configured to maintain a generally constant spring force. It may be appreciated that the cam-lock 108 may also be used to increase and/or decrease the spring force.

To remove the mobile device 170 from the adjustable mobile device holder 100, the user may rotate the cradle adjustment knob 106 in an opposite direction (e.g., counterclockwise) to cause the threaded rod 112 to retreat within the second slot and thread out of the threaded fastener. By rotating the cradle adjustment knob 106 in the opposite direction, the cradle may be adjusted such that the first cradle portion 102 and the second cradle portion 104 are spread or further spaced apart. For example, rotating the cradle adjustment knob 106 may cause the threaded rod 112 to retreat within the second slot and thread out of the threaded fastener, which may cause the first cradle portion 102 to move away from the second cradle portion 104 thereby spreading the upper holding arms 114a and 114c apart. As the cradle adjustment knob 106 spreads the first cradle portion 102 and the second cradle portion 104 apart, the force exerted by the spring may be reduced and the mobile device 170 may be removed from the adjustable mobile device holder 100. For example, the threaded fastener may be mobile or movable within the second slot such that as the first cradle portion 102 and the second cradle portion 104 are spread apart, a pressure may be at least partially released from the mobile device 170. Because the threaded rod 112 may be threaded into the threaded fastener, the decrease in pressure may cause the threaded fastener to move within the second slot away from the first cradle portion 102 and the spring may be at least partially decompressed. If desired, the cradle adjustment knob 106 may continue to be rotated in the same direction until the upper holding arms 114a and 114c no longer engage the mobile device 170 and the spring force may be reduced, such as to around zero.

In some embodiments, the spring force may be reduced by disengaging the cam-lock 108. For example, the cam lever 110 may be manipulated by the user (e.g., lifted upward) such that the cam-lock 108 is disengaged. The disengagement of the cam-lock 108 may allow the spring to slightly decompress and that may reduce the spring force, which may facilitate removing the mobile device 170 from the adjustable mobile device holder 100. In some embodiments, the decompression of the spring may cause the upper holding arm 114a and the upper holding arm 114c to spread apart or may facilitate separation of the upper holding arm 114a and the upper holding arm 114c.

As illustrated in FIG. 1B-1D, the threaded rod 112 may couple, at least in part, the first cradle portion 102 and the second cradle portion 104. In some embodiments, the threaded rod 112 may be coupled to the cradle adjustment knob 106. For example, the threaded rod 112 may be coupled to the cradle adjustment knob 106 via the cam-lock 108 and/or a second threaded fastener 109.

In these and other embodiments, the second threaded fastener 109 may couple the threaded rod 112 to the cam-lock 108. The second threaded fastener 109 may be a barrel nut, a cross dowel, a threaded insert, or any other suitable fastener, which may allow for the threaded rod 112 to be rotated as the cradle adjustment knob 106 is rotated. The second threaded fastener 109 is described in more detail with respect to FIGS. 1F-1G.

As illustrated in FIG. 1B, the first cradle portion 102 and/or the second cradle portion 104 may include one or more tabs 116. For example, the first cradle portion 102 may include the first tab 116a and the second tab 116b. The one or more tabs 116 may extend from either of the cradle portions and extend into and/or be aligned with a recess (not shown) in the other cradle portion. For example, the first tab 116a may extend from the first cradle portion 102 into a recess in the second cradle portion 104. The tabs 116 may help couple the first cradle portion 102 and the second cradle portion 104, and the tabs 116 may help ensure that the first cradle portion 102 and the second cradle portion 104 are substantially aligned, which may help secure the mobile device 170 within the cradle at least partially formed by the first cradle portion 102 and the second cradle portion 104. The one or more tabs 116 are explained in more detail with reference to FIGS. 1F-1G.

As illustrated in FIG. 1B-1D, the first cradle portion 102 may include one or more holding arms 114, such as the upper holding arm 114a and the lower holding arm 114b, and the second cradle portion 104 may include one or more holding arms 114, such as the upper holding arm 114c and the lower holding arm 114d. In some embodiments, the holding arms 114 may be coupled to the first cradle portion 102 and/or the second cradle portion 104 (e.g., by a male-female connection, by a fastener, by adhesive, or any other suitable technique for coupling the holding arms 114 to the first cradle portion 102 and/or the second cradle portion 104). In some embodiments, the holding arms 114 may be detachable from the first cradle portion 102 and/or the second cradle portion 104. In some embodiments, the holding arms 114 may be integral with the first cradle portion 102 and/or the second cradle portion 104. For example, the holding arms 114a and 114b may be integral with the first cradle portion 102 such that the holding arms 114a and 114b and the first cradle portion 102 are one unit, such as a unitary, one-piece structure or multiple components interconnected to form a single structure. In another example, the holding arms 114c and 114d may be integral with the second cradle portion 104 such that the holding arms 114c and 114d and the second cradle portion 104 are one unit, such as a unitary, one-piece structure or multiple components interconnected to form a single structure.

In some embodiments, each of the holding arms 114 may be the same size or a comparable size. In some embodiments, the holding arms 114 may be different sizes. For example, the upper holding arms 114a and 114c may be sized differently than the lower holding arms 114b and 114d. In some embodiments, the holding arms 114 may be interchangeable. In some embodiments, the first cradle portion 102 and/or the second cradle portion 104 may be shaped such that the cradle portions provide horizontal and/or vertical support to the holding arms 114. For example, as illustrated in FIG. 1C, the first cradle portion 102 and the second cradle portion 104 may extend outwardly to provide horizontal support to the upper holding arms 114a and 114c and vertical support to the lower holding arms 114b and 114d.

In some embodiments, the holding arms 114 may be constructed from elastomeric materials (e.g., rubber, neoprene, or other suitable elastomeric materials), polymeric foams (e.g. polyurethane foam, polyethylene foam, polypropylene foam, or other suitable foams), gels (e.g., silicone gel, hydrogel, or other suitable gels), plastics, or any other suitable material. In some embodiments, the holding arms 114 may be constructed from composite or hybrid materials.

In some embodiments, at least one of the holding arms 114 may have an inner wall 118 and the inner wall may be sized and configured to engage the mobile device 170. For example, the holding arms 114a-114d may each have an inner wall 118a-118d, and the inner walls may be sized and configured to engage the mobile device 170. In some embodiments, the inner wall 118 may engage the mobile device 170 at a first engagement point and a second engagement point. This may allow, for example, a space to be disposed between the first engagement point, the second engagement point, and/or at least a portion of the inner wall 118. This is further described with reference to FIG. 1E. In these and other embodiments, the inner wall 118 may be substantially U-shaped, substantially V-shaped, substantially parabolic, or any other shape in which a space may be disposed between the first engagement point, the second engagement point, and/or a portion of the inner wall 118. In some embodiments, the portion of the inner wall 118 may include a rounded or curved vertex 120 and the rounded vertex may at least partially define the space. For instance, the inner wall 118 of at least one of the holding arms 114 may be substantially V-shaped and may include the rounded vertex 120. For example, each of the holding arms 114a-114d may have inner walls 118a-118d that may be substantially V-shaped with rounded vertexes 120a-120d. In these and other embodiments, a portion of the inner wall 118 may extend obliquely from each side of the rounded vertex 120.

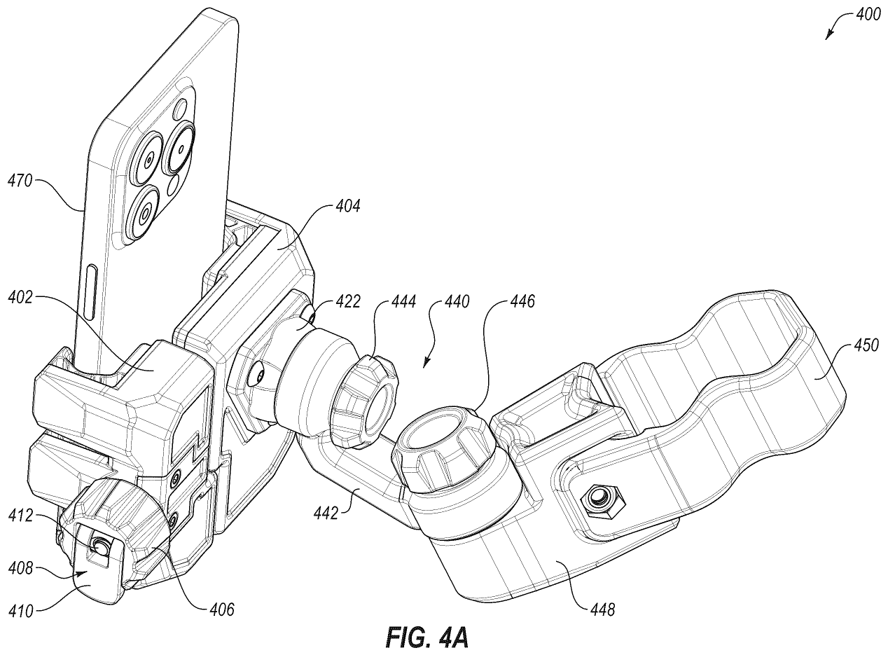

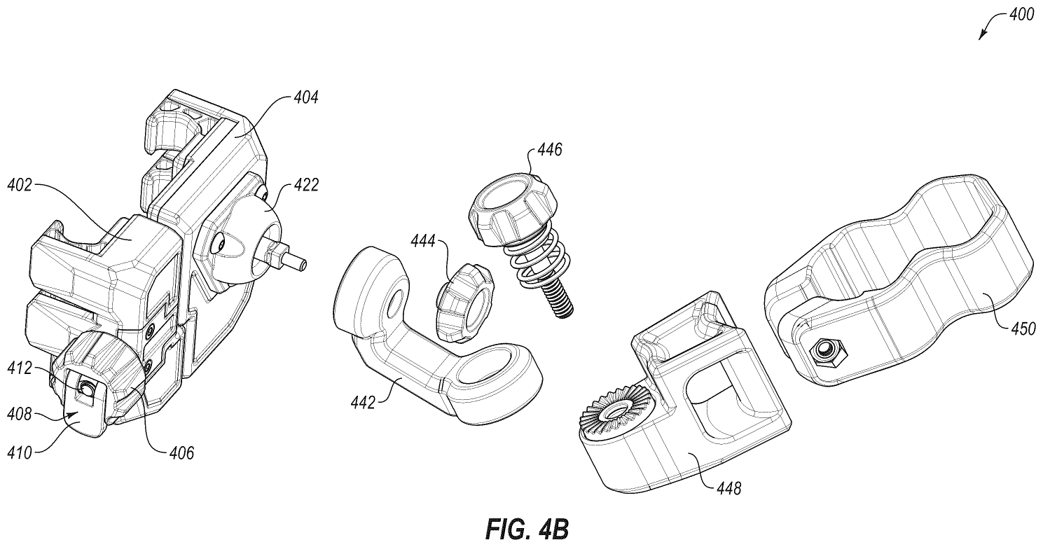

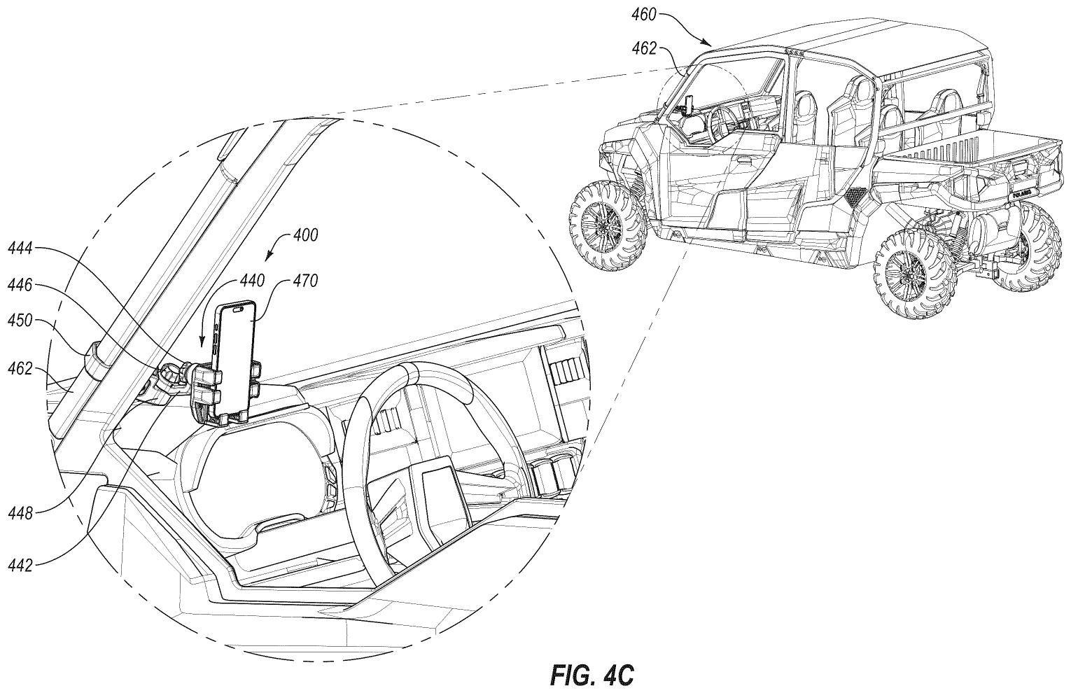

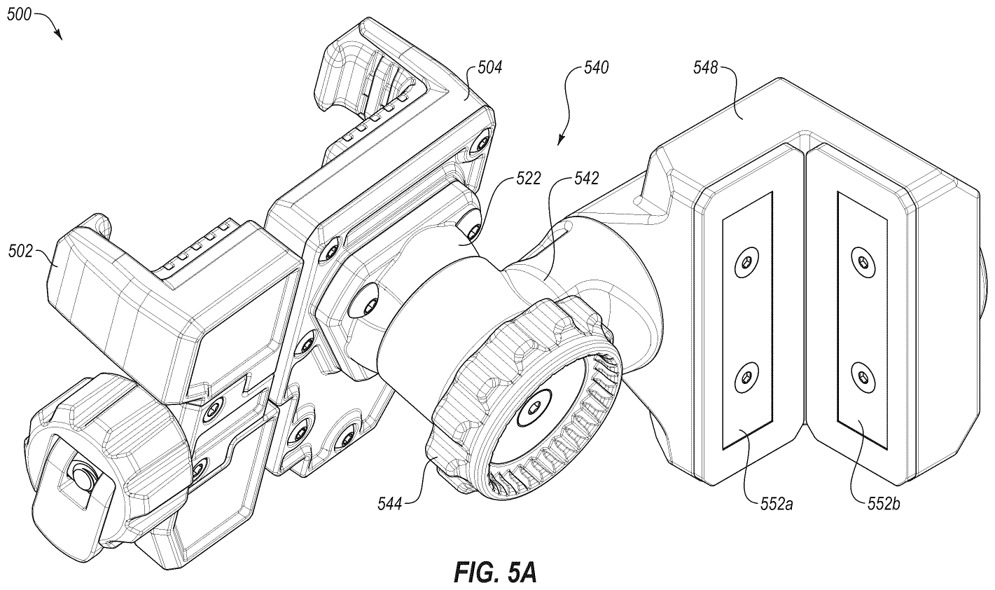

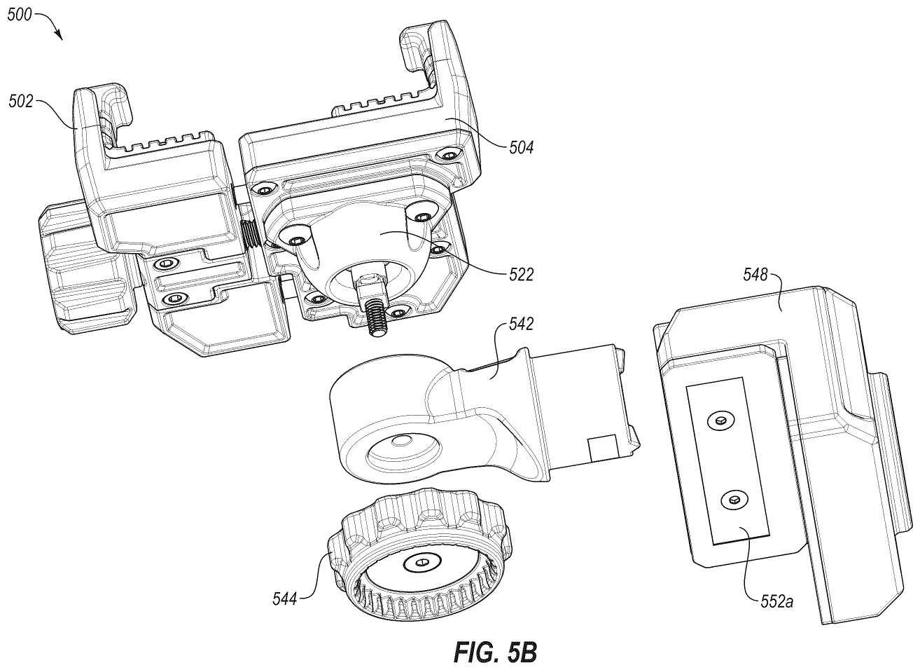

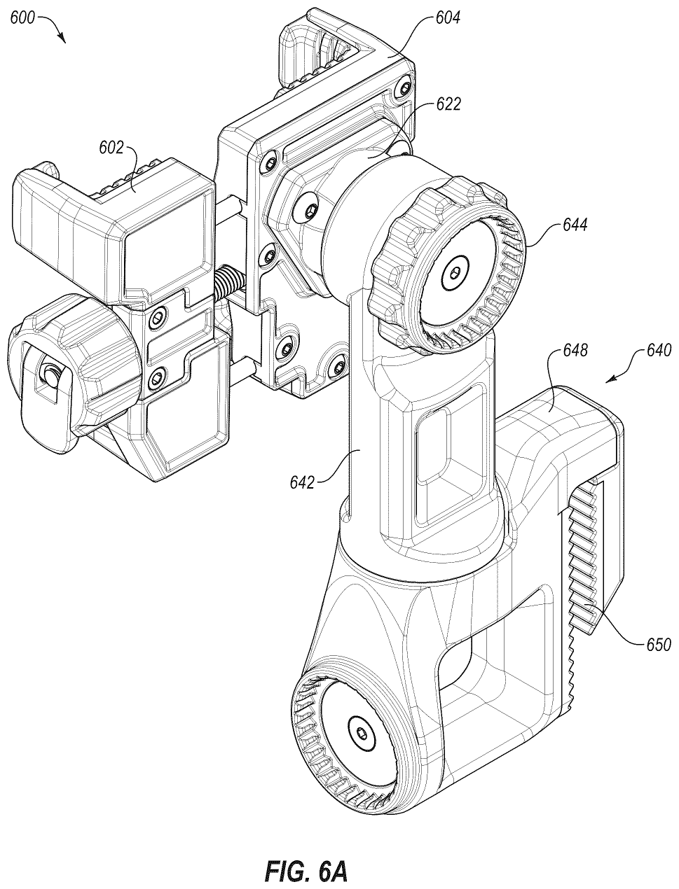

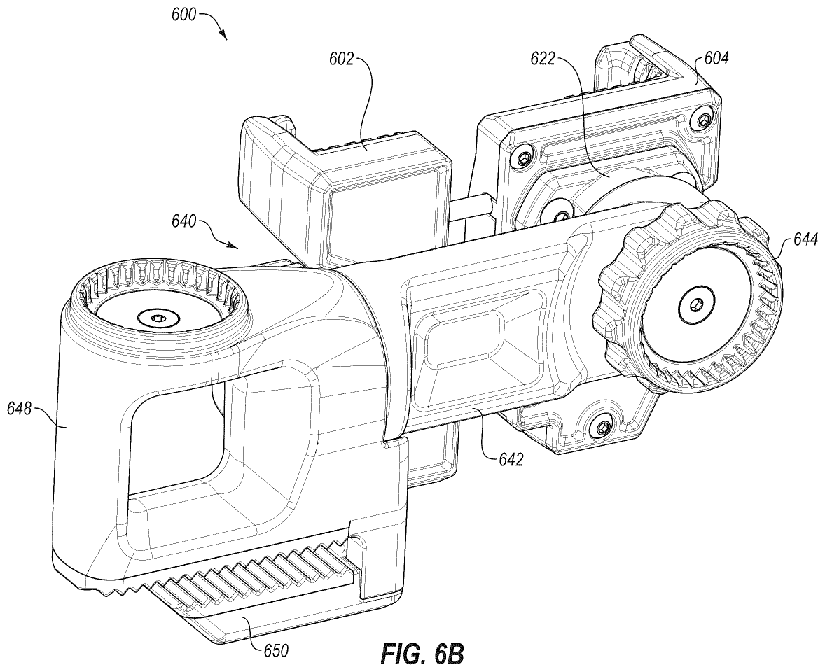

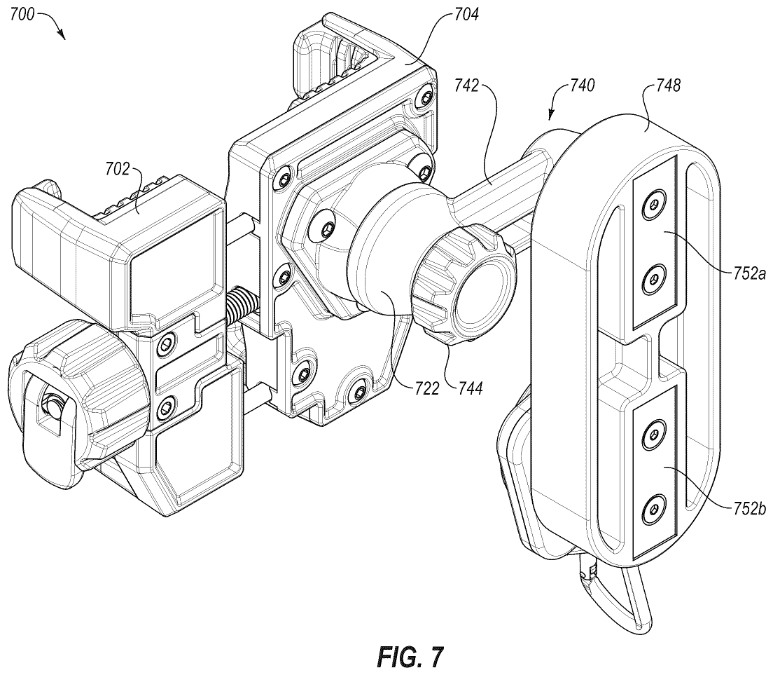

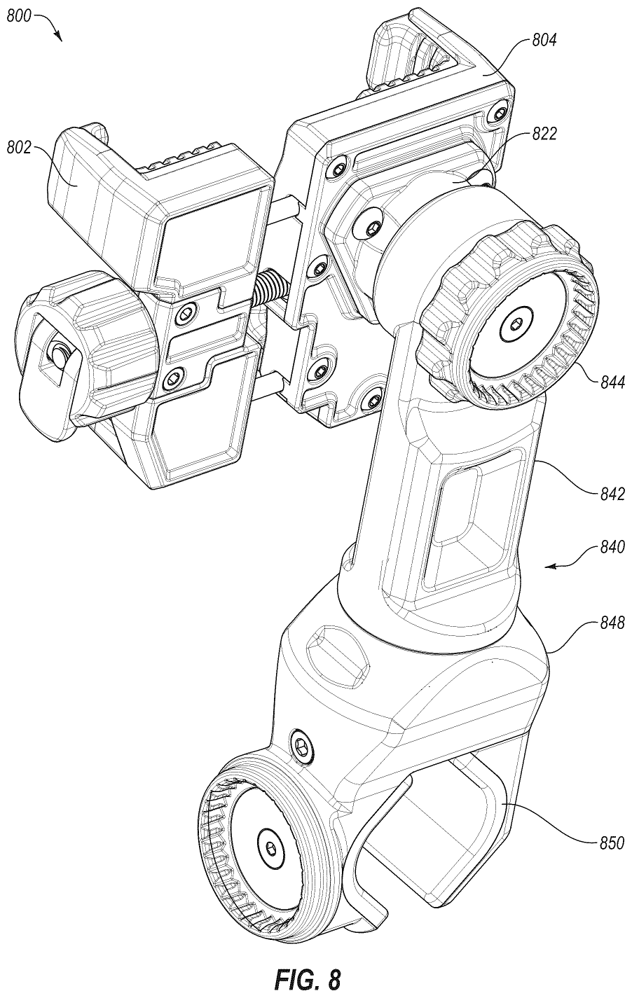

In some embodiments, the first cradle portion 102 and/or the second cradle portion 104 may be coupled to a mounting interface 122. As illustrated in FIG. 1D, the second cradle portion 104 may be coupled to the mounting interface 122. Additionally, or alternatively, the first cradle portion 102 may be coupled to the mounting interface 122. The mounting interface 122 may be part of a device mount (as described with reference to FIG. 4A-4C, FIG. 5A-5B, FIG. 6A-6B, FIG. 7, and FIG. 8), and the mounting interface may provide a coupling point between the first cradle portion 102, the second cradle portion 104, and/or the device mount. As illustrated in FIG. 1D, the mounting interface 122 may be a ball and socket joint, which may allow the cradle to be adjusted horizontally, diagonally, and/or vertically by a user. In some embodiments, the mounting interface 122 may be a magnet, a hinge, a swivel mechanism, a gooseneck mechanism, a sliding rail, a telescoping arm, or any other suitable interface.

FIG. 1E illustrates the lower holding arm 114d of the second cradle portion 104 engaging the mobile device 170. As illustrated in FIG. 1E, the inner wall 118b of the lower holding arm 114b may be substantially V-shaped and include the rounded vertex 120b. It will be appreciated that all or a portion of the holding arms 114 may have a similar size, shape, configuration, and/or arrangement.

In some embodiments, the inner wall 118 of the holding arms 114 may engage the mobile device 170 at a first engagement point 124a and a second engagement point 124b such that a space 126 is disposed between the first engagement point 124a, the second engagement point 124b, and at least a portion of the inner wall 118. For example, such as illustrated in FIG. 1E, the inner wall 118b of the lower holding arm 114b may be configured to engage the mobile device 170 at the first engagement point 124a and the second engagement point 124b, and the space 126 may be disposed between the inner wall 118b and the engagement points 124.

The space 126 may be disposed between the inner wall 118 and the engagement points 124, and the space may facilitate the mobile device 170 being centered in the cradle. In some embodiments, the space 126 may allow for the mobile device 170 to be placed within the holding arms 114 without interfering with buttons on the mobile device 170. For example, the upper holding arm 114a and the upper holding arm 114c may be configured in a similar fashion to the lower holding arm 114b (as illustrated in FIG. 1E), which may allow for buttons (e.g., power buttons, volume buttons, or any other controls) on the sides of the mobile device 170 to have enough clearance in the space 126 such that the buttons on the mobile device 170 may not be contacted by the holding arms 114. Thus, the mobile device 170 may be secured by the adjustable mobile device holder 100 without the adjustable mobile device holder 100 interfering with the functionality of the mobile device 170.

In some embodiments, the holding arms 114 may be modified to change the size of the space 126, such as increasing the height and/or decreasing the length of the space 126. For example, the slope at which the inner wall 118b departs from the rounded vertex 120b may be increased on one or both sides of the rounded vertex 120b, which may change the first engagement point 124a and/or the second engagement point 124b to be higher relative to those illustrated in FIG. 1E. The holding arms 114 may also be modified to decrease the height of the space 126 and/or increase the length of space 126. For example, the slope at which the inner wall 118b departs from the rounded vertex 120b may be decreased on one or both sides of the rounded vertex 120b, which may change the first engagement point 124a and/or the second engagement point 124b to be lower relative to those illustrated in FIG. 1E.

While a substantially V-shaped inner wall is illustrated in FIG. 1E, it will be appreciated that the inner wall 118 may take on other shapes. For example, the inner wall 118 may be substantially U-shaped, substantially parabolic, or any other shape. In other embodiments, the inner wall 118 of one or more of the holding arms 114 may be substantially flat such that the space 126 is lacking or negligible. In addition, the vertexes may not be rounded. For example, the inner walls 118 of the holding arms 114 may be V-shaped with a sharp vertex.

As illustrated in FIGS. 1F-1G, the adjustable mobile device holder 100 may include the first cradle portion 102 and the second cradle portion 104. The first cradle portion 102 may be coupled to the second cradle portion 104. The adjustable mobile device holder 100 may further include the threaded rod 112. The threaded rod 112 may couple, at least in part, the first cradle portion 102 to the second cradle portion 104.

The threaded rod 112 may be partially disposed within a first slot 128 in the first cradle portion 102 and may be at least partially disposed within a second slot 130 in the second cradle portion 104. In some embodiments, portions of the threaded rod 112 may be unthreaded. For example, end portions of the threaded rod 112 may be threaded and a middle portion may be unthreaded. In some embodiments, the threaded rod 112 may have a circular cross-section, a square cross-section, a rectangular cross-section, or any other suitable shape. In some embodiments, the threaded rod 112 may have right-hand threads, left-hand threads, unified thread standard (UTS) threads, metric threads, Acme threads, square threads, buttress threads, or any other suitable thread. In some embodiments, the threaded rod 112 may be coupled to the second threaded fastener 109 and the second threaded fastener 109 may be disposed proximate an end portion of the threaded rod 112. The second threaded fastener 109 may also couple the threaded rod 112 to the cam-lock 108 and/or the cradle adjustment knob 106.

A threaded fastener 134 may be disposed in the second slot 130 and may receive the threaded rod 112. In some embodiments, the threaded fastener 134 may have a circular cross-section, a square cross-section, a rectangular cross-section, or any other suitable shape to receive the threaded rod 112. In some embodiments, the threaded rod 112 may have right-hand threads, left-hand threads, unified thread standard (UTS) threads, metric threads, Acme threads, square threads, buttress threads, or any other suitable thread that may receive the threaded rod 112. In some embodiments, the threaded fastener 134 may be a nut, a threaded insert, or any other fastener that may receive the threaded rod 112.

In some embodiments, the threaded fastener 134 may be mobile or movable within the second slot 130. The threaded fastener 134 may be configured to move toward the first cradle portion 102 as the cradle is decreased in size and a spring 132, which may be at least partially disposed in the second slot 130, may be compressed. For example, as the threaded rod 112 threads into the threaded fastener 134 and pressure is applied to the mobile device 170 placed within the cradle, the pressure applied to the mobile device 170 may be transmitted to the threaded rod 112 influencing the threaded rod 112 to move out of the second slot 130. Because the threaded rod 112 may be threaded into the threaded fastener 134, this pressure may be transmitted to the threaded fastener 134, which may cause the threaded fastener 134 to move within the second slot 130 toward the first cradle portion 102 and compress the spring 132. The threaded fastener 134 may be configured to move away from the first cradle portion 102 as the cradle is increased in size such that the spring 132 may be at least partially decompressed. For example, as pressure is released from the mobile device 170, the pressure transmitted to the threaded rod 112 may be decreased, which may cause the threaded fastener 134 to move within the second slot 130 away from the first cradle portion 102 and at least partially decompress the spring 132.

In some embodiments, the spring 132 may be disposed in the second slot 130 of the second cradle portion 104. As illustrated in FIG. 1F, the spring 132 may be disposed in the second slot 130 forward of the threaded fastener 134 such that the spring 132 is closer to the first cradle portion 102 than the threaded fastener 134. In some embodiments, the threaded rod 112 may run through or be disposed within at least a portion of the spring 132, and the spring 132 may be sized and configured such that the spring 132 does not interfere with the threaded rod 112 threading into or out of the threaded fastener 134. The spring 132 may exert a force as the first cradle portion 102 and the second cradle portion 104 are tightened against the mobile device 170. For example, the cradle adjustment knob 106 may be rotated in a clockwise direction causing the threaded rod 112 to advance within the second slot 130 and tighten the first cradle portion 102 and the second cradle portion 104 against the mobile device 170 (e.g., via the holding arms 114 or otherwise), which may compress the spring 132 and cause the spring 132 to exert a spring force that may be translated to the holding arms 114. For example, the threaded fastener 134 may move toward the first cradle portion 102 within the second slot 130 and compress the spring 132. In some embodiments, the spring force may be increased to hold the mobile device 170 more securely by further rotation of the cradle adjustment knob 106 and may be decreased to hold the mobile device 170 less securely or to facilitate removal of the mobile device 170 from the cradle by rotating the cradle adjustment knob 106 in an opposite direction.

In some embodiments, the second slot 130 may be uniformly shaped, but the second slot may other have suitable shapes, such as a tapered shape. For example, such as illustrated in FIG. 1F, the second slot 130 may have a greater height and/or width in the section where the threaded fastener 134 and the spring 132 are disposed than the second slot 130 does at a more proximal section (e.g., away from the first cradle portion 102). In some embodiments, the second slot 130 may be at least partially threaded such that the threaded fastener 134 may be omitted.

The first cradle portion 102 and/or the second cradle portion 104 may include one or more tabs 116. For example, the first cradle portion 102 may include the first tab 116a and the second tab 116b. In some embodiments, the one or more tabs 116 may extend from the first cradle portion 102 and/or the second cradle portion 104. In these and other embodiments, the first cradle portion 102 and/or the second cradle portion 104 may include one or more recesses or receiving portions 136. For example, the second cradle portion 104 may include a first recess 136a and a second recess 136b. In these embodiments, each tab of the one or more tabs 116 may extend from one of the cradle portions into a recess of the one or more recesses 136 in the other cradle portion. For example, such as illustrated in FIG. 1F, the first tab 116a may extend from the first cradle portion 102 into a first recess 136a in the second cradle portion 104 and/or the second tab 116b may extend from the first cradle portion 102 into a second recess 136b in the second cradle portion 104. The tabs 116 may, at least partially, couple the first cradle portion 102 and the second cradle portion 104, and the tabs may help ensure that the first cradle portion 102 and the second cradle portion 104 are substantially aligned such that the mobile device 170 may be adequately secured within the cradle.

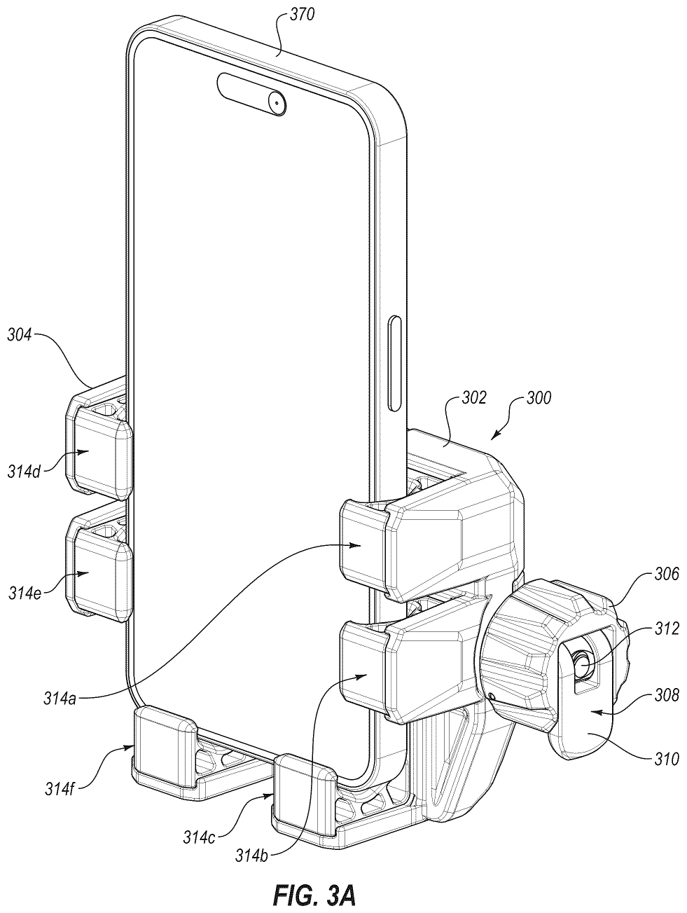

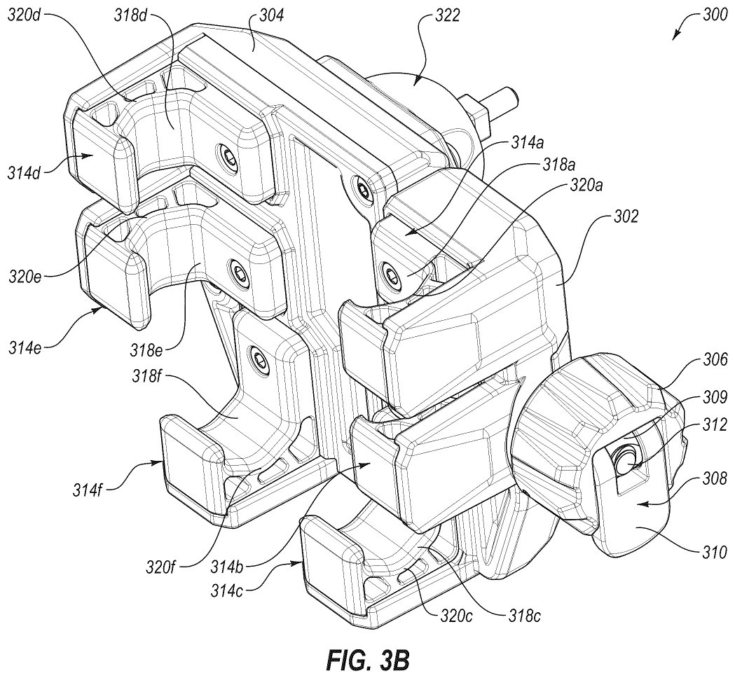

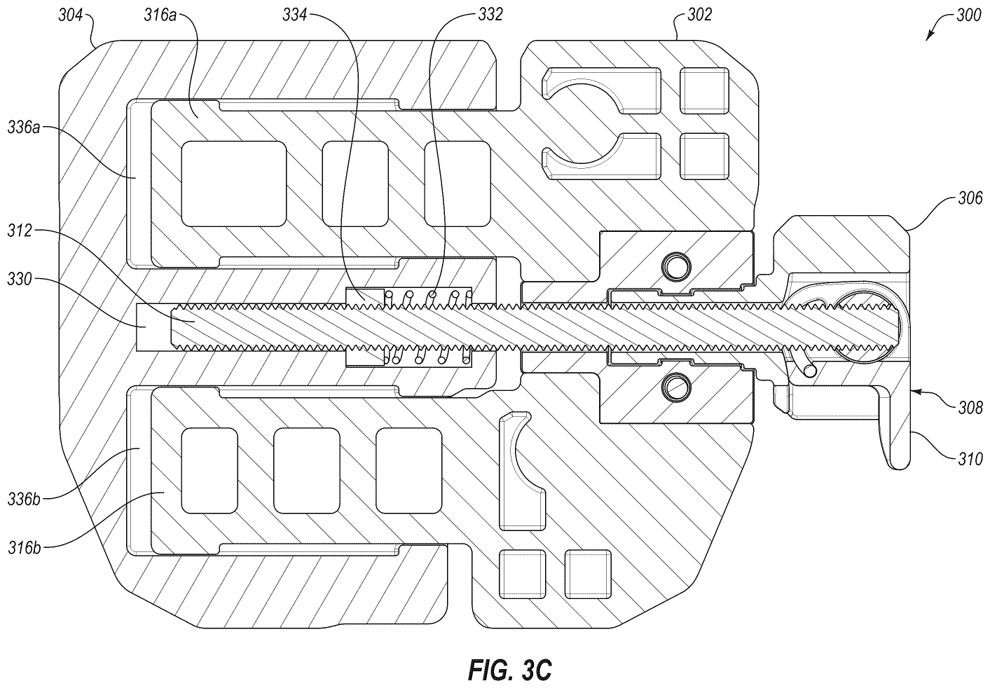

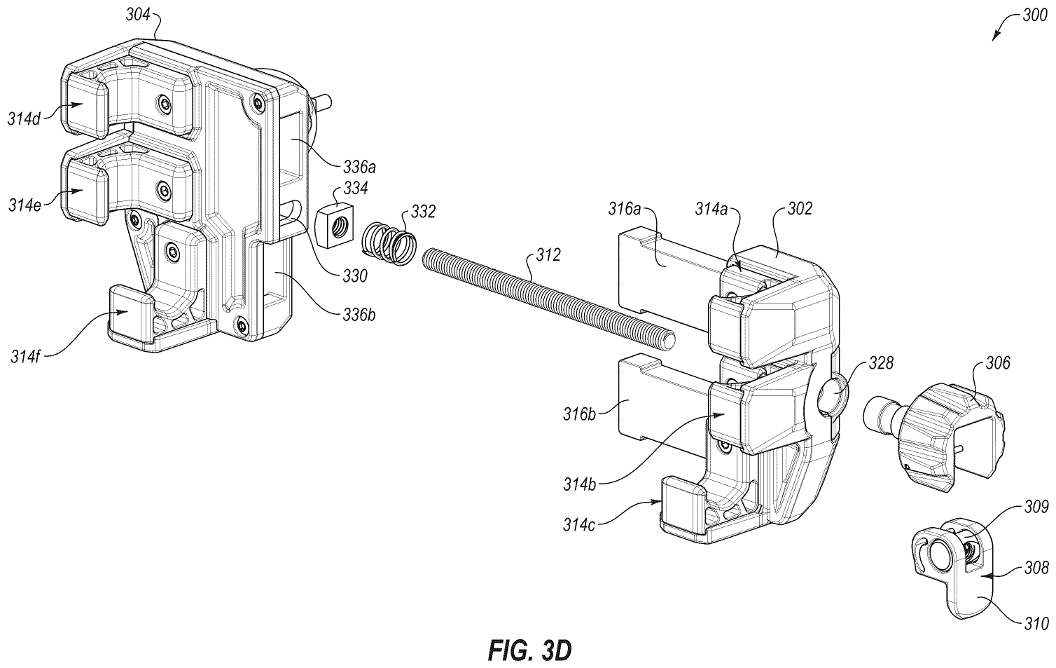

In some embodiments, such as illustrated in FIG. 1F, the one or more tabs 116 may be rods and the one or more recesses 136 may be openings having a shape and size to receive the rods. The one or more tabs 116 may also be protrusions (e.g., the tabs 316a and 316b as illustrated in FIGS. 3C-3D) and the one or more recesses 136 may be openings having a shape and size configured to receive the protrusions (e.g., the recesses 336a and 336b). In other embodiments, the one or more tabs 116 and the one or more recesses 136 may respectively be a tail and pin, rivet and hole, key and keyseat, or any other male-female combination which may fit together when the first cradle portion 102 and the second cradle portion 104 are coupled together.

In some embodiments, the one or more tabs 116 may be detachable from the first cradle portion 102 and/or the second cradle portion 104. For example, the first tab 116a and the second tab 116b may be rods having threads that may thread into and out of corresponding threads in the first cradle portion 102 and/or the second cradle portion 104. In some embodiments, the one or more tabs 116 may be integral with the first cradle portion 102 and/or the second cradle portion 104. For example, the first tab 116a and/or the second tab 116b may be integral with the first cradle portion 102 such that the first tab 116a, the second tab 116b, and the first cradle portion 102 form one unit.

In some embodiments, the one or more tabs 116 and the one or more recesses 136 may form one or more captured tab-and-recess joints. For example, the one or more recesses 136 may allow linear motion (e.g., sliding inwardly and/or outwardly as the threaded rod 112 is threaded into and/or out of the threaded fastener 134) up to a point, but removal of the one or more tabs 116 from the one or more recesses 136 may be prevented. An example embodiment is illustrated and described with respect to FIG. 3C-3D.

In some embodiments, the adjustable mobile device holder 100 may further include the cam-lock 108. In these embodiments, the cam-lock 108 may include a cam lever 110. In some embodiments, the cam-lock 108 may be coupled to the threaded rod 112 at an end portion of the threaded rod 112 via the second threaded fastener 109. In these embodiments, the second threaded fastener 109 may be a barrel nut, a cross dowel, a threaded insert, or any other suitable fastener, which may allow for cam-lock 108 to be coupled to the second threaded fastener 109. In some embodiments, the cam lever 110 may engage and disengage the cam-lock 108. For example, the cam lever 110 may be manipulated by a user to position the cam lever 110 parallel to the first cradle portion 102 (e.g., the cam lever 110 is pressed down by the user) to engage the cam-lock 108 or to position the cam lever 110 perpendicular to the first cradle portion 102 to disengage the cam-lock 108 (e.g., the cam lever 110 is lifted up by the user).

In some embodiments, such as illustrated in FIG. 1G, the second threaded fastener 109 may fit in a hole extending through the cam-lock 108. The hole may have a slightly eccentric profile such that, as the cam lever 110 is engaged, the cam-lock 108 may rotate about the second threaded fastener 109 (e.g., in a clockwise direction) and frictionally lock into place. The engagement of the cam-lock 108 may cause the holding arms 114 to apply pressure to the mobile device 170 placed within the cradle. As previously discussed, the engagement of the cam-lock 108 may maintain or increase the spring force exerted by the spring 132. For example, the pressure exerted against the mobile device 170 due to the engagement of the cam-lock 108 may be translated to the threaded rod 112. Because the threaded rod 112 may be threaded into the threaded fastener 134, the threaded fastener 134 may move within the second slot 130 and may compress the spring 132 due to the engagement of the cam-lock 108. Additionally, as the cam lever 110 is disengaged, the cam-lock 108 may rotate about the second threaded fastener 109 (e.g., in a counterclockwise direction), which may release the force applied by the holding arms 114 against the mobile device 170 placed within the cradle. For example, the pressure exerted against the mobile device 170 may be at least partially released by the disengagement of the cam-lock 108, which may cause the threaded fastener to move within the second slot 130 away from the first cradle portion 102 and may at least partially decompress the spring 132. In these and other embodiments, as the cam-lock 108 is disengaged, the spring force exerted by the spring 132 may be reduced. The engagement of the cam-lock 108 may cause the upper holding arms 114a and 114c to tighten against the mobile device 170. In some embodiments, disengagement of the cam-lock 108 may cause the upper holding arms 114a and 114c to spread apart, which may space the first cradle portion 102 and the second cradle portion 104 apart. Thus, engagement of the cam-lock 108 may help secure the mobile device 170 within the adjustable mobile device holder 100 and disengagement of the cam-lock 108 may allow the mobile device 170 to be removed.

The adjustable mobile device holder 100 may further include the cradle adjustment knob 106. In some embodiments, the cradle adjustment knob 106 may be coupled to the threaded rod 112 at an end portion of the threaded rod 112. Thus, rotation of the cradle adjustment knob 106 in one direction (e.g., clockwise) may cause the threaded rod 112 advance within the second slot 130 and thread into the threaded fastener 134 and rotation of the cradle adjustment knob 106 in an opposite direction (e.g., counterclockwise) may cause the threaded rod 112 to retreat within the second slot 130 and thread out of the threaded fastener 134.

In some embodiments, the cradle adjustment knob 106 may be coupled to the threaded rod 112 via the cam-lock 108 and/or the second threaded fastener 109. The second threaded fastener 109 may be a barrel nut, a cross dowel, a threaded insert, or any other suitable fastener, which may allow for the threaded rod 112 to be rotated with the cradle adjustment knob 106. Due to the engagement between the cradle adjustment knob 106, and the cam-lock 108 and/or the second threaded fastener 109, rotation of the cradle adjustment knob 106 in one direction (e.g., clockwise) may cause the cam-lock 108 and/or the second threaded fastener 109, and the threaded rod 112 to rotate in the same direction. The threaded rod 112 may advance within the second slot 130 (e.g., in a direction into the second cradle portion 104), and thread into the threaded fastener 134. If the mobile device 170 is placed within the cradle, rotation of the cradle adjustment knob 106 may cause pressure to be applied to the mobile device 170, which may cause the spring 132 to compress. Rotation of the cradle adjustment knob 106 in an opposite direction (e.g., counterclockwise) may cause the cam-lock 108 and/or the second threaded fastener 109, and the threaded rod 112 to rotate in the same direction. In these and other embodiments, the threaded rod 112 may retreat within the second slot 130 (e.g., in a direction out of the second cradle portion 104) and thread out of the threaded fastener 134.

The cradle adjustment knob 106 may include an unthreaded shaft extending from the cradle adjustment knob 106. For example, the unthreaded shaft of the cradle adjustment knob 106 may be partially disposed within the first slot 128. In some embodiments, the first slot 128 may be threaded and the cradle adjustment knob 106 may include a threaded shaft which may thread into the first slot 128. The shaft of the cradle adjustment knob 106 may include internal threads which may receive the threaded rod 112 and the threaded rod 112 may be threaded into the cradle adjustment knob 106.

In operation, the mobile device 170 may be placed within the adjustable mobile device holder 100. The cradle adjustment knob 106 may be rotated in one direction (e.g., clockwise) which may cause the threaded rod 112 to advance within the second slot 130 and thread into the threaded fastener 134. In embodiments where the one or more tabs 116 and the one or more recesses 136 are included, rotation of the cradle adjustment knob 106 may cause the tabs 116 to advance within the recesses 136. As the threaded rod 112 advances within the second slot 130, the first cradle portion 102 and the second cradle portion 104 may move closer together and may tighten against the mobile device 170. As the cradle is decreased in size, pressure may be applied to the mobile device 170. The tightening of the first cradle portion 102 and the second cradle portion 104 (e.g., at the holding arms 114) may cause the spring 132 to exert a force, which may allow the mobile device 170 to be held more securely. For example, the threaded fastener 134 may move within the second slot 130 to compress the spring 132 as the cradle is decreased in size and as pressure is applied to the mobile device 170. The cradle adjustment knob 106 may be rotated further in the same direction by the user to increase the amount of spring force exerted by the spring 132 or may be rotated in an opposite direction to decrease the amount of spring force exerted by the spring 132. In embodiments including the cam-lock 108, the cam-lock 108 may be engaged, which may at least maintain the spring force. The cam-lock 108 may cause the first cradle portion 102 and the second cradle portion 104 to move closer together and/or tighten against the mobile device 170 allowing for the mobile device 170 to be held more securely.

The mobile device 170 may be removed by rotating the cradle adjustment knob 106 in an opposite direction (e.g., counterclockwise) which may cause the threaded rod 112 to retreat within the second slot 130 and thread out of the threaded fastener 134. In embodiments where the one or more tabs 116 and the one or more recesses 136 are included, rotation of the cradle adjustment knob 106 may cause the tabs 116 to retreat within the recesses 136. As the threaded rod 112 retreats within the second slot 130, the first cradle portion 102 and the second cradle portion 104 may spread apart and loosen the securement of the mobile device 170. The spacing of the first cradle portion 102 and the second cradle portion 104 (e.g. at the holding arms 114) may reduce the spring force, which may allow the mobile device 170 to be held less securely within the adjustable mobile device holder 100 and/or may allow the mobile device 170 to be removed from the adjustable mobile device holder 100. For example, as the cradle is increased in size, pressure against the mobile device 170 may be decreased, which may cause the threaded fastener 134 to move away from the first cradle portion 132 and at least partially decompress the spring 132.

Additionally, or alternatively, the cam-lock 108 may be disengaged to reduce the force exerted by the spring 132. The cam-lock 108 disengagement may cause the first cradle portion 102 and the second cradle portion 104 to spread apart, which may allow for removal of the mobile device 170. The cam-lock 108 disengagement may cause the force exerted by the spring 132 to be decreased. For example, the cam-lock 108 disengagement may cause the threaded fastener 134 to move away from the first cradle portion 102 such that the spring 132 is at least partially decompressed.

After reviewing this disclosure, one skilled in the art will appreciate that modifications, additions, or omissions may be made to the adjustable mobile device holder 100. For example, the designations of different elements in the manner described is meant to help explain concepts herein and is not limiting. Further, the example adjustable mobile device holder 100 may include any number of other elements or may be implemented within other systems or contexts than those described. For example, in some embodiments, the one or more tabs 116 and the one or more recesses 136 may be omitted. Furthermore, more or less holding arms 114 may be included. For example, and as illustrated in FIG. 3A-3E, the adjustable mobile device holder 100 may include additional upper holding arms. In another example, the lower holding arms 114b and 114d may be omitted. In some embodiments, the threaded fastener 134 may be omitted, the second slot 130 may be at least partially threaded, and the threaded rod 112 may thread into the second slot 130. In some embodiments, the cam-lock 108 may be omitted.

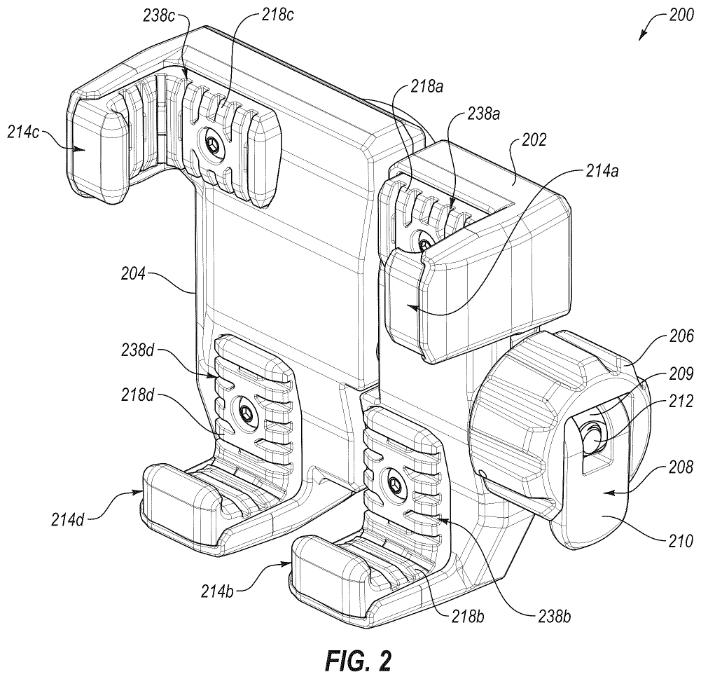

Furthermore, the adjustable mobile device holder 100 may include additional features, such as those described in this disclosure. For example, the holding arms 114 of the adjustable mobile device holder 100 may include the sets of protrusions described with reference to FIG. 2 or the device mounts described with reference to FIGS. 4-8.

Additionally, the examples provided describe rotating the cradle adjustment knob 106 clockwise to cause the threaded rod 112 to advance within the second slot 130 and rotating the cradle adjustment knob 106 counterclockwise to cause the threaded rod 112 to retreat within the second slot 130. It will be appreciated, that these components may be configured in a reverse orientation where rotation in a counterclockwise direction causes the threaded rod 112 to advance within the second slot 130 and rotation in a clockwise direction causes the threaded rod 112 to retreat within the second slot 130. For example, the threaded rod 112 and the threaded fastener 134 may be left-hand threaded.

Additionally, the examples provided describe the threaded rod 112 and the threaded fastener 134, but other connectors and/or fasteners may be used. For example, keyed or slotted mechanisms may be utilized in lieu of the threaded rod 112 and the threaded fastener 134. For example, a J-lock rod with one or more J-locks and a J-lock fastener may be utilized. Furthermore, a detent mechanism may be utilized.

FIG. 2 illustrates an example adjustable mobile device holder 200 with holding arms 214 including sets of one or more protrusions 238. The components of the adjustable mobile device holder 200 may be similar to or the same as similar or related components illustrated in this disclosure. For example, the adjustable mobile device holder 200 may include a first cradle portion 202, a second cradle portion 204, a cradle adjustment knob 206, a cam-lock 208, a second threaded fastener 209, a cam lever 210, a threaded rod 212, and/or one or more holding arms 214 having an inner wall 218, which may all be similar to or the same as similarly named components described in FIGS. 1A-1G. In addition, although not illustrated in FIG. 2, the example adjustable mobile device holder 200 may include one or more tabs, one or more recesses, threaded fastener, spring, first slot, and/or second slot, such as described with reference to FIG. 1.

As illustrated in FIG. 2, the first cradle portion 202 may include an upper holding arm 214a and a lower holding arm 214b, and the second cradle portion 204 may include an upper holding arm 214c and a lower holding arm 214b. In some embodiments, any of the holding arms 214 may include a set of one or more protrusions 238, and the protrusions may extend from an inner wall 218 of the holding arms 214. For example, a first set of one or more protrusions 238a may extending from the inner wall 218a of the upper holding arm 214a, a second set of one or more protrusions 238b may extend from the inner wall 218b of the lower holding arm 214b, a third set of one or more protrusions 238c may extend from the inner wall 218c of the upper holding arm 214c, and/or a fourth set of one or more protrusions 238d may extend from the inner wall 218d of the lower holding arm 214d.

The sets of one or more protrusions 238 may help grip a mobile device, such as the mobile device 170 shown in FIG. 1. For example, the sets of one or more protrusions 238 may help create a friction or interference fit, which help secure the mobile device within the cradle. The sets of one or more protrusions 238 may also provide some cushioning or padding, which may help protect the mobile device and/or may assist in creating a secure engagement with the mobile device. In some embodiments, the sets of one or more protrusions 238 may include one or more ridges, nubs, teeth, hooks, studs, pegs, dots, serrations, bumps, grooves, prongs, fingers, and the like. For example, the sets of one or more protrusions 238 illustrated in FIG. 2 may include multiple raised ridges, which may assist in gripping the mobile device when the device is placed within the holding arms 214. In some embodiments, the sets of one or more protrusions 238 may be configured differently for different holding arms 214. For example, the first set of one or more protrusions 238a and the third set of one or more protrusions 238c may be raised ridges, and the second set of one or more protrusions 238b and the fourth set of one or more protrusions 238d may be studs. In some embodiments, each of the sets of one or more protrusions 238 may have differently shaped protrusions. For example, the first set of one or more protrusions 238 may have both raised ridges and studs.

In some embodiments, the protrusions of the sets of protrusions 238 may be distributed at even spacing along the inner wall 218 or at variable spacing along the inner wall 218. In some embodiments, the sets of one or more protrusions 238 may extend from a portion of the inner wall 218. For example, the sets of one or more protrusions 238 may extend from the portion of the inner wall 218 that engages the mobile device.

In some embodiments, the geometry and/or texture of the protrusions in the sets of protrusions 238 may increase the coefficient of friction between the mobile device and the holding arms 214. Thus, the sets of one or more protrusions 238 may help secure the mobile device, and the protrusions may help prevent slippage during use of the adjustable mobile device holder 200.

In some of these embodiments, such as illustrated in FIG. 2, the inner wall 218 of the holding arms 214 may be substantially flat. In some embodiments, the inner wall 218 of the holding arms 214 may be substantially U-shaped, substantially V-shaped, substantially parabolic, or any other shape having a rounded vertex. For example, the inner wall 218 may be shaped similarly to the inner wall 118 described with respect to FIG. 1E.

After reviewing this disclosure, one skilled in the art will appreciate that modifications, additions, or omissions may be made to the adjustable mobile device holder 200. For example, the designations of different elements in the manner described is meant to help explain concepts herein and is not limiting. Further, the example adjustable mobile device holder 200 may include any number of other elements or may be implemented within other systems or contexts than those described. For example, in some embodiments, the first set of one or more protrusions 238a, the second set of one or more protrusions 238b, the third set of one or more protrusions 238c, and/or the fourth set of one or more protrusions 238d may be omitted. Furthermore, in some embodiments the holding arms 214 may be omitted and the sets of one or more protrusions 238 may extend from the first cradle portion 202 and/or the second cradle portion 204.

FIG. 3A-3B illustrate an example adjustable mobile device holder 300 with and without a mobile device 370 The components of the adjustable mobile device holder 300 may be similar to or the same as similar or related components illustrated in this disclosure. For example, the adjustable mobile device holder 300 may include a first cradle portion 302, a second cradle portion 304, a cradle adjustment knob 306, a cam-lock 308, a cam lever 310, a threaded rod 312, one or more holding arms 314, one or more tabs 316, a mounting interface 322, a first slot 328, a second slot 330, a spring 332, a threaded fastener 334, and one or more recesses 336, any or all of which may all be similar to or the same as similarly named components described in FIGS. 1A-1G. For instance, any or all of the one or more holding arms 314 may have an inner wall 318 that engages the mobile device 370 at a first engagement point and a second engagement point, and the inner wall 318 may include a rounded vertex 320.

As illustrated in FIGS. 3A-3B and 3E, the first cradle portion 302 and the second cradle portion 304 may include one or more holding arms 314 which may hold the mobile device 370 in place. In some embodiments, the first cradle portion 302 may include a first upper holding arm 314a, a second upper holding arm 314b, and a lower holding arm 314c. The second cradle portion 304 may include a first upper holding arm 314d, a second upper holding arm 314e, and a lower holding arm 314f. The upper holding arms 314a and 314b may engage one side of the mobile device 370, and the upper holding arms 314d and 314e may engage an opposite side of the mobile device 370. The lower holding arms 314c and 314f may engage a bottom side or portion of the mobile device 370.

As illustrated in FIG. 3B, the holding arms 314 may all have a similar shape to the shape of the holding arms 114 described with respect to FIG. 1. For example, the inner wall 318d of the upper holding arm 314d may be substantially V-shaped with a rounded vertex 320d.

As illustrated in FIGS. 3C-3D, the adjustable mobile device holder 300 may include one or more tabs or protrusions 316, and one or more recesses 336 may have a shape and size to receive the protrusions 316. The one or more tabs 316 and the one or more recesses 336 may form one or more captured tab-and-recess joints. For example, when the adjustable mobile device holder 300 is operated to move the first cradle portion 302 and the second cradle portion 304 closer together or further apart, the one or more tabs 316 may move within the one or more recesses 336. The tabs 316, in an exemplary embodiment, may not be fully removed from the one or more recesses 336. For example, the one or more recesses 336 may have one or more receiving portions and the one or more tabs 316 may have engaging portions that are disposed in the receiving potions to prevent the one or more tabs 316 from fully sliding out of the one or more recesses 336.

In operation, the adjustable mobile device holder 300 may function in a substantially similar fashion to the other disclosed adjustable mobile device holders, such as the adjustable device holder 100 described with reference to FIG. 1.

One skilled in the art, after reviewing this disclosure, that modifications, additions, or omissions may be made to the adjustable mobile device holder 300. Further, the example adjustable mobile device holder 300 may include any number of other elements or may be implemented within other systems or contexts than those described. Furthermore, the adjustable mobile device holder 300 may include additional features, such as those described in this disclosure. For example, the holding arms 314 of the adjustable mobile device holder 300 may include the sets of one or more protrusions described with reference to FIG. 2, or the device mounts described with reference to FIGS. 4-8.

FIGS. 4A-4B illustrate an example adjustable mobile device holder 400 including an example device mount 440. The adjustable mobile device holder 400 may have the same or similar components as the adjustable mobile device holders described in this disclosure. For example, the adjustable mobile device holder 400 may include a first cradle portion 402, a second cradle portion 404, a cradle adjustment knob 406, a cam-lock 408, a cam lever 410, a threaded rod 412, and a device mount 440, which may function similarly to or the same as similarly named components described in this disclosure.

The device mount 440 may be coupled to the first cradle portion 402 and/or the second cradle portion 404. The device mount 440 may include a mount base 448, a mounting arm 442 that may be coupled to the mount base 448, and a mounting interface 422. The mounting interface 422 may be coupled to the mounting arm 442, and the mounting interface 422 may be coupled to the first cradle portion 402 and/or the second cradle portion 404. The mount base 448 may allow the adjustable mobile device holder 400 to be mounted to a structure or surface. For example, the mount base 448 may allow the adjustable mobile device holder 400 to be mounted to a vehicle such as a car, ATV, UTV, golf cart, and the like.

In some embodiments, such as illustrated in FIG. 4A-4C, the mounting interface 422 may be a ball and socket joint, and the mounting interface may allow the cradle to be adjusted horizontally, diagonally, and/or vertically by a user. The mounting interface 422 may also be a magnet, a hinge, a swivel mechanism, a gooseneck mechanism, a sliding rail, a telescoping arm, or any other suitable structure or device that may couple the first cradle portion 402 and/or the second cradle portion 404 to the device mount 440. In some embodiments, multiple mounting interfaces 422 may be included. For example, the first cradle portion 402 and the second cradle portion 404 may each include a mounting interface and the mounting arm 442 may be coupled to either or both of the mounting interfaces.

In some embodiments, the device mount 440 may include a first mount adjustment knob 444 and the first mount adjustment knob 444 may be coupled to the mounting interface 422. The first mount adjustment knob 444 may help couple the mounting arm 442 and the mounting interface 422. The first mount adjustment knob 444 may tighten the mounting interface 422 between the mounting arm 442 and the first cradle portion 402 and/or the second cradle portion 404 when rotated in one direction (e.g., clockwise) and may loosen the mounting interface 422 between the mounting arm 442 and the first cradle portion 402 and/or the second cradle portion 404 when rotated in an opposite direction (e.g., counterclockwise). For example, the mounting interface 422 may be a ball and socket joint and the first mount adjustment knob 444 may be rotated in a clockwise direction which may compress the socket around the ball. Tightening the ball and socket joint may limit horizontal, diagonal, and/or vertical movement of the first cradle portion 402 and/or the second cradle portion 404, and the user may secure the adjustable mobile device holder 400 in a desired position. Also, the user may rotate the first mount adjustment knob 444 in an opposite direction (e.g., counterclockwise) which may loosen the ball and socket joint and allow the adjustable mobile device holder 400 to be adjusted horizontally, diagonally, and/or vertically.

In these and other embodiments, the device mount 440 may include a second mount adjustment knob 446 and the second mount adjustment knob 446 may be coupled to the mount base 448. The second mount adjustment knob 446 may be coupled to the mounting arm 442. Rotating the second mount adjustment knob 446 in one direction (e.g., clockwise) may tighten the mounting arm 442 to the mount base 448 and may limit movement of the mounting arm 442 relative to the mount base 448. This may allow the user to secure the mounting arm 442 in a desired position relative to the mount base 448. Rotating the second mount adjustment knob 446 in an opposite direction (e.g., counterclockwise) may loosen the mounting arm 442 from the mount base 448 and allow movement of the mounting arm 442 relative to the mount base 448. As illustrated in FIG. 4B, the second mount adjustment knob 446 may include a threaded shaft which may thread into an opening configured to receive the shaft in the mount base 448. In these instances, the mounting arm 442 may laterally or horizontally pivot about the threaded shaft coupling the mounting arm 442 to the mount base 448. In some embodiments, the mounting arm 442 may be coupled to the mount base 448 via a mounting interface such as the mounting interface 422 described previously. For example, a ball and socket joint may couple the mounting arm 442 to the mount base 448.

The mounting interface 422 may be coupled directly to the mount base 448. The mounting interface 422 may also be coupled to the mount base 448 via the mounting arm 442.

The mount base 448 may couple the device mount 440 to a support surface or structure. For example, the support surface may be a surface or structure on a vehicle such as an all-terrain vehicle (ATV), a utility task vehicle (UTV), a golf cart, a car, a truck, or any other vehicle. The support surface may also be a roll bar or support member of a golf cart, UTV, ATV, etc. The support surface may be any suitable surface or structure, such as part of a golf bag. It will be appreciated that the support surface or structure could be any suitable structure or device, including sporting goods equipment. In some embodiments, the mount base 448 may couple the device mount 440 to the support surface via a fastener. In some embodiments, the fastener may be a magnet, an adhesive, a strap, a bolt, a screw, a clamp, and/or the any other suitable fastener. For example, a clamp 450 may couple the device mount 440 to the support surface. In these and other embodiments, the clamp 450 may be sized and configured to allow the mount base 448 to be coupled to a support surface or structure such as a portion of an ATV, a UTV, a bar on a push cart, a golf bag, or any other surface which may provide support to the device mount 440. In some embodiments, the clamp 450 may be adjustable in size and the clamp 450 may include portions that are flexible and/or compressible, which may facilitate coupling of the clamp 450 to a support surface. In some embodiments, the clamp 450 may be secured in a desired position by a fastener such as a screw or a locking pin.

FIG. 4C illustrates the example adjustable mobile device holder 400 coupled to a vehicle 460 via the example device mount 440. As illustrated, the mount base 448 may be coupled to a support surface 462 on the vehicle 460 via a clamp 450. In some embodiments, such as illustrated in FIG. 4C, the support surface 462 may be a roll bar or roof support of the vehicle 460. The user may adjust the position of the adjustable mobile device holder 400 by manipulating the first mount adjustment knob 444 and/or the second mount adjustment knob 446. For example, the first mount adjustment knob 444 may be rotated counterclockwise by a user to allow the user to move the coupled cradle portions horizontally, vertically, and/or diagonally to achieve a desired position. In this instance, the user may then rotate the first mount adjustment knob 444 clockwise in order to maintain the desired position. In another example, the second mount adjustment knob 446 may be rotated counterclockwise by a user to allow the user to move the mounting arm 442 laterally/horizontally about a pivot point between the mounting arm 442 and the mount base 448. In this instance, the user may move the coupled cradle portions inwards towards the passenger side of the vehicle 460 or outwards towards the driver side window of the vehicle 460.

After reviewing this disclosure, one skilled in the art will appreciate that modifications, additions, or omissions may be made to the adjustable mobile device holder 400. For example, the example adjustable mobile device holder 400 may include any number of other elements or may be implemented within other systems or contexts than those described. For instance, the mounting arm 442 may be omitted and the mount base 448 may be coupled directly to the mounting interface 422. Additionally, in some embodiments, the mounting interface 422 may be omitted and the mounting arm 442 and/or the mount base 448 may be directly coupled to the first cradle portion 402 and/or the second cradle portion 404. Furthermore, the adjustable mobile device holder 400 may include additional features, such as those described in this disclosure.

The adjustable mobile device holder 400 is shown as utilizing a clamp 450 for illustrative purposes and other fasteners (e.g., magnets, adhesives, screws, and the like) suitable to couple the mount base 448 to a support surface may be utilized. Additionally, the support surface 462 shown as a roll bar on the vehicle 460 is for illustrative purposes, and it will be understood that the adjustable mobile device holder 400 may be coupled to any support surface on a vehicle 460 (e.g., the dashboard, an AC vent, or any other suitable support surface) and/or the adjustable mobile device holder 400 may be coupled to other vehicles such as a golf cart, an ATV, a car, or a truck. Furthermore, the adjustable mobile device holder 400 need not be coupled to a vehicle. For example, the adjustable mobile device holder 400 may be coupled to other support surfaces on non-vehicular structures such as a pushcart, a golf bag, or any other suitable support surface.

Additionally, the first mount adjustment knob 444 and/or the second mount adjustment knob 446 may be omitted. Furthermore, the first mount adjustment knob 444 and/or the second mount adjustment knobs 446 are described as being configured such that clockwise rotation causes tightening and counterclockwise rotation causes loosening. It will be appreciated that the first mount adjustment knob 444 and/or the second mount adjustment knob 446 may be configured such that counterclockwise rotation causes tightening and clockwise rotation causes loosening.

FIGS. 5A-5B illustrate another example adjustable mobile device holder 500 and the adjustable mobile device holder may include example device mount 540. The adjustable mobile device holder 500 may have the same or similar components to the adjustable mobile device holders described in this disclosure. For example, the adjustable mobile device holder 500 may include a first cradle portion 502, a second cradle portion 504, and a device mount 540, which may function similarly to and/or may have similar or related components to to those described in this disclosure.

The device mount 540 may be coupled to the first cradle portion 502 and/or the second cradle portion 504. The device mount 540 may include a mount base 548, a mounting arm 542 coupled to the mount base 548, and a mounting interface 522 coupled to the mounting arm 542 and coupled to the first cradle portion 502 and/or the second cradle portion 504.

As illustrated in FIGS. 5A-5B, in some embodiments, the mounting arm 542 may be coupled to the second cradle portion 502. The device mount 540 may include a mount adjustment knob 544, which may be coupled to the mounting interface 522 and/or the mounting arm 542. The mount adjustment knob 544 may tighten the mounting interface 522 between the mounting arm 542 and the first cradle portion 502 and/or the second cradle portion 504 when rotated in one direction (e.g., clockwise). The mount adjustment knob 544 may loosen the mounting interface 522 between the mounting arm 542 and the first cradle portion 502 and/or the second cradle portion 504 when rotated in an opposite direction (e.g., counterclockwise). The mount adjustment knob 544 may be similar to or the same as the first mount adjustment knob 444 described with respect to FIG. 4A-4C.

In some embodiments, the mounting arm 542 may be fixedly secured to the mount base 548 such that the mounting arm 542 may not be rotated relative to the mount base 548. For example, the mounting arm 542 may be secured with a screw, a bolt, an adhesive, or a magnet. The mounting arm 542 may be detachable from the mount base 548. The mounting arm 542 may be integral with the mount base 548 such that the mounting arm 542 and the mount base 548 are one unit, whether formed as part of a unitary, one-piece structure or multiple components interconnected to form a single structure.

The mount base 548 may be coupled to a support surface via a fastener. In some embodiments, the fastener may include one or more magnets 552. For instance, the mount base 548 may include a first magnet 552a and a second magnet 552b, and the mount base 548 may be coupled to the support surface via the one or more magnets 552. For example, the mount base 548 may be coupled to a support surface on the vehicle 460 described with respect to FIG. 4C using the one or more magnets 552. In an example embodiment, the first magnet 552a may be disposed on a first portion such as a first side of the mount base 548, and the second magnet 552b may be disposed on a second portion such as a second side of the mount base 548. As illustrated in FIG. 5A-5B, the mount base 548 may have a generally L-shaped configuration, and the mount base 548 may include the first magnet 552a disposed on a first side of the generally L-shaped configuration and the second magnet 552b disposed on a second side of the generally L-shaped configuration. The one or more magnets 552 on the first side of the mount base 548 and the one or more magnets 552 on the second side of the mount base 548 may cooperate, work together, and/or be aligned to allow the mount base 548 to be coupled to a support surface or structure.

After reviewing this disclosure, one skilled in the art will appreciate modifications, additions, or omissions may be made to the adjustable mobile device holder 500. For example, the example adjustable mobile device holder 500 may include any number of other elements or may be implemented within other systems or contexts than those described. For instance, the mounting arm 542 may be omitted and the mount base 548 may be coupled directly to the mounting interface 522. Additionally, the mounting interface 522 may be omitted and the mounting arm 542 and/or the mount base 548 may be directly coupled to the first cradle portion 502 and/or the second cradle portion 504. Furthermore, the adjustable mobile device holder 500 may include additional features, such as one or more features described in this disclosure. For example, the adjustable mobile device holder 500 may include a second mount adjustment knob such as the second mount adjustment knob 446 described with respect to FIG. 4. In addition, the mount adjustment knob 544 may be omitted.

FIGS. 6A-6B illustrate another example adjustable mobile device holder 600 including another example device mount 640. In some embodiments, the adjustable mobile device holder 600 may have the same or similar components to the adjustable mobile device holders described in this disclosure. For example, the adjustable mobile device holder 600 may include a first cradle portion 602, a second cradle portion 604, and a device mount 640, which may all function similarly to and/or have similar components as similarly named components described in this disclosure.

The device mount 640 may be coupled to the first cradle portion 602 and/or the second cradle portion 604. The device mount 640 may include the mounting interface 622, a mounting arm 642, and a mount base 648. The mount base 648 may couple the device mount 640 to a support surface. The mounting arm 642 may be coupled to the mount base 648. The mounting interface 622 may be coupled to the mounting arm 642 and coupled to the first cradle portion 602 and/or the second cradle portion 604.

The adjustable mobile device holder 600 may be coupled to a support surface via a fastener such as a clamp 650. The clamp 650 may be sized and configured to allow the mount base 648 to be coupled to a support surface or structure such as a golf bag. In some embodiments, the clamp 650 may be adjustable in size and the clamp 650 may include portions that are flexible and/or compressible, which may facilitate coupling of the clamp 650 to the support surface. In some embodiments, the clamp 650 may be secured in a desired position by a fastener such as a screw or locking pin. In some embodiments, the clamp 650 may include multiple teeth on an interior surface of the clamp 650 that may engage the support surface and couple the device mount 640 to the support surface. In these embodiments, the teeth may create a frictional grip that resists removal of the adjustable mobile device holder 600 from the support surface.

In some embodiments, the adjustable mobile device holder 600 may include a mount adjustment knob 644. Rotation of the mount adjustment knob 644 in one direction may tighten the mounting interface 622 between the mounting arm 642 and the first cradle portion 602 and/or the second cradle portion 604, and rotation of the mount adjustment knob 644 in an opposite direction may loosen the mounting interface 622 between the mounting arm 642 and the first cradle portion 602 and/or the second cradle portion 604.

The mount adjustment knob 644 may allow the mounting arm 642 to be moved horizontally, vertically, and/or diagonally relative to the mounting interface 622. For example, as illustrated in FIG. 6A, the device mount 640 may be positioned vertically such that the mounting arm 642 extends downwardly relative to the mounting interface 622. In this instance, this position may be maintained by the user rotating the mount adjustment knob 644, for example, in a clockwise direction, to tighten the mounting interface 622 and limit movement. As illustrated in FIG. 6B, the device mount 640 may be adjusted such that the mounting arm 642 extends horizontally relative to the mounting interface 622. For example, from the position of the device mount 640 shown in FIG. 6A, the mount adjustment knob 644 may be rotated such that the mounting interface 622 is loosened and allows for movement of the device mount 640. In this instance, the user may then move the device mount 640 relative to the mounting interface 622 such that the mounting arm 642 extends horizontally relative to the mounting interface 622. This may allow the overall footprint of the adjustable mobile device holder 600 to be reduced for storage.

After reviewing this disclosure, one skilled in the art will appreciate that modifications, additions, or omissions may be made to the adjustable mobile device holder 600. For example, the mounting arm 642 may be omitted and the mount base 648 may be coupled directly to the mounting interface 622. Additionally, the mounting interface 622 may be omitted and the mounting arm 642 and/or the mount base 648 may be directly coupled to the first cradle portion 602 and/or the second cradle portion 604. Furthermore, the adjustable mobile device holder 600 may include any of the additional features, such as one or more features described in this disclosure. For example, the adjustable mobile device holder 600 may include a second mount adjustment knob such as the second mount adjustment knob 446 described with respect to FIG. 4. In addition, the mount adjustment knob 644 may be omitted.

FIG. 7 illustrates another example adjustable mobile device holder 700 including another example device mount 740. The adjustable mobile device holder 700 may have the same or similar components to the adjustable mobile device holders described in this disclosure. For example, the adjustable mobile device holder 700 may include a first cradle portion 702, a second cradle portion 704, and a device mount 740, which may function similarly to similar components described in this disclosure.

The device mount 740 may be coupled to the first cradle portion 702 and/or the second cradle portion 704. The device mount 740 may include a mount base 748, a mounting arm 742, and a mounting interface 722. The mounting interface 722 and the mounting arm 742 may be similar to those described in this disclosure.

The mount base 748 may also be similar to the mount bases described in this disclosure. In some embodiments, such as described with reference to FIG. 5A-5B, the mount base 748 may be coupled to a support surface via one or more magnets 752, which may be similar or the same as the one or more magnets 552. For example, the adjustable mobile device holder 700 may include a first magnet 752a and a second magnet 754a, which may be similar to the first magnet 552a and the second magnet 552b. In these embodiments, the mount base 748 may include a first base portion which may include both the first magnet 752a and the second magnet 752b. In these embodiments, the one or more magnets 752 may be sized and configured to allow the mount base 748 to be magnetically coupled to a support surface. If desired, the first magnet 752a may be spaced apart from the second magnetic 752b by a distance.

In some embodiments, the device mount 740 may include a mount adjustment knob 744. In these embodiments, the mount adjustment knob 744 may function similarly to or the same as the mount adjustment knobs described in this disclosure.

after reviewing this disclosure, one skilled in the art will appreciate that modifications, additions, or omissions may be made to the adjustable mobile device holder 700. For example, the mounting arm 742 may be omitted and the mount base 748 may be coupled directly to the mounting interface 722. Additionally, the mounting interface 722 may be omitted and the mounting arm 742 and/or the mount base 748 may be directly coupled to the first cradle portion 702 and/or the second cradle portion 704. Furthermore, the adjustable mobile device holder 700 may include any of the other features described in this disclosure. For example, the adjustable mobile device holder 700 may include a second mount adjustment knob such as the second mount adjustment knob 446 described with respect to FIG. 4. In addition, the mount adjustment knob 744 may be omitted. Also, the first magnet 752a and/or the second magnet 754a may be omitted.

FIG. 8 illustrates another example adjustable mobile device holder 800 including another example device mount 840. The adjustable mobile device holder 800 may have the same or similar components to the adjustable mobile device holders described in this disclosure. For example, the adjustable mobile device holder 800 may include a first cradle portion 802, a second cradle portion 804, and a device mount 840, which may all function similarly to or have similar components as similarly named components described in this disclosure.

The device mount 840 may be coupled to the first cradle portion 802 and/or the second cradle portion 804. The device mount 840 may include a mount base 848, a mounting arm 842, and a mounting interface 822. The mounting interface 822 and the mounting arm 842 may be similar to those described in this disclosure. In some embodiments, the device mount 840 may include a mount adjustment knob 844. In these embodiments, the mount adjustment knob 844 may function similarly to or the same as the mount adjustment knobs described in this disclosure.

The mount base 848 may be coupled to a support surface via a fastener such as a clamp 850. As illustrated in FIG. 8, the clamp 850 may be a compression clamp that may be configured to couple the device mount 840 to a support surface such as a push cart.

The clamp 850 may be sized and configured to allow the mount base 848 to be coupled to a support surface or structure. In some embodiments, the clamp 850 may be adjustable in size and the clamp 850 may include portions that are flexible and/or compressible, which may facilitate attachment of the clamp 850 to a support surface such as a support or roll bar on a golf cart or a pushcart. In some embodiments, the clamp 850 may be secured in a desired position by a fastener such as a screw or a locking pin.

In operation, the user may push the clamp 850 against the support surface such that the support surface enters the clamp 850. The interior surface of the clamp 850 may press against the support surface such that the clamp 850 may couple the device mount 840 to the support surface.

After reviewing this disclosure, one skilled in the art will appreciate that modifications, additions, or omissions may be made to the adjustable mobile device holder 800. For example, the mounting arm 842 may be omitted and the mount base 848 may be coupled directly to the mounting interface 822. Additionally, the mounting interface 822 may be omitted and the mounting arm 842 and/or the mount base 848 may be directly coupled to the first cradle portion 802 and/or the second cradle portion 804. Furthermore, the adjustable mobile device holder 800 may include features, such as those described in this disclosure. For example, the adjustable mobile device holder 800 may include a second mount adjustment knob such as the second mount adjustment knob 446 described with respect to FIG. 4. In addition, the mount adjustment knob 844 may be omitted.

The various features illustrated in the drawings may be, but are not necessarily, drawn to scale. The illustrations may be views of one or more portions of a particular apparatus (e.g., device, system, etc.) or method, and the illustrations may be idealized representations that are employed to describe various embodiments of the disclosure. Accordingly, the dimensions of the various features may be shown, or may be arbitrarily expanded or reduced for clarity. In addition, some of the drawings may be simplified for clarity. Thus, the drawings may not depict all the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. An adjustable mobile device holder comprising:
a first cradle portion;
a second cradle portion, the first cradle portion and the second cradle portion forming at least a portion of a cradle capable of receiving a mobile device;
a connector partially disposed within a first slot in the first cradle portion and partially disposed within a second slot in the second cradle portion, the connector at least partially connecting the first cradle portion to the second cradle portion;
a cradle adjustment knob coupled to the connector such that rotation of the cradle adjustment knob in one direction causes a size of the cradle to be decreased and rotation of the cradle adjustment knob in an opposite direction causes the size of the cradle to be increased; and
a spring disposed in the second slot of the second cradle portion, the spring configured to exert a force as the size of the cradle is decreased.

2. The adjustable mobile device holder of claim 1, wherein the connector is a threaded rod, the threaded rod connected to a threaded fastener disposed in the second slot of the second cradle portion;
wherein rotation of the cradle adjustment knob in the one direction causes the threaded rod to advance within the second slot and thread into the threaded fastener; and
wherein rotation of the cradle adjustment knob in the opposite direction causes the threaded rod to retreat within the second slot and thread out of the threaded fastener.

3. The adjustable mobile device holder of claim 2, wherein the threaded fastener is movable within the second slot, the threaded fastener being configured to move toward the first cradle portion as the cradle is decreased in size such that the threaded fastener compresses the spring, and the threaded fastener being configured to move away from the first cradle portion as the cradle is increased in size such that the spring is at least partially decompressed.

4. The adjustable mobile device holder of claim 3, wherein the threaded fastener is configured to move within the second slot as pressure is applied to a mobile device placed within the cradle such that the spring is compressed by the threaded fastener and the threaded fastener is configured to move within the second slot as pressure is released, at least partially, from the mobile device placed within the cradle such that the spring, is at least partially, decompressed.

5. The adjustable mobile device holder of claim 1, further comprising:
a cam-lock coupled to the connector, the cam-lock being configured to at least maintain the force exerted by the spring when engaged and to reduce the force exerted by the spring when disengaged.

6. The adjustable mobile device holder of claim 1, wherein the cradle adjustment knob adjusts the size of the cradle by tightening the first cradle portion and the second cradle portion against the mobile device or spreading the first cradle portion and the second cradle portion apart.

7. The adjustable mobile device holder of claim 1, wherein the first cradle portion and the second cradle portion include one or more holding arms.

8. The adjustable mobile device holder of claim 7, wherein an inner wall of at least one of the one or more holding arms is configured to engage the mobile device at a first engagement point and a second engagement point; and
wherein a space is disposed between the first engagement point and the second engagement point.

9. The adjustable mobile device holder of claim 8, wherein the inner wall of the at least one of the one or more holding arms is substantially V-shaped with a rounded vertex.

10. The adjustable mobile device holder of claim 7, wherein at least one of the one or more holding arms includes a set of protrusions extending from an inner wall of the holding arm, the set of protrusions configured to grip the mobile device within the cradle.

11. The adjustable mobile device holder of claim 1, wherein the force exerted by the spring is independent of a spacing of the first cradle portion and the second cradle portion.

12. The adjustable mobile device holder of claim 1, further comprising a device mount coupled to at least one of the first cradle portion or the second cradle portion, the device mount including:
a mount base configured to couple the device mount to a support surface;
a mounting arm coupled to the mount base; and
a mounting interface coupled to the mounting arm and coupled to at least one of the first cradle portion or the second cradle portion.

13. The adjustable mobile device holder of claim 12, wherein the device mount includes a mount adjustment knob coupled to the mounting interface, the mount adjustment knob tightening the mounting interface between the mounting arm and at least one of the first cradle portion or the second cradle portion when rotated in one direction and loosening the mounting interface between the mounting arm and at least one of the first cradle portion or the second cradle portion when rotated in an opposite direction.

14. The adjustable mobile device holder of claim 12, wherein the device mount includes a mount adjustment knob coupled to the mounting base, the mount adjustment knob tightening the mounting arm to the mounting base when rotated in one direction and loosening the mounting arm when rotated in an opposite direction.

15. The adjustable mobile device holder of claim 1, wherein at least one of the first cradle portion or the second cradle portion includes one or more tabs and at least one of the first cradle portion or the second cradle portion includes one or more recesses, each tab extending from one of the cradle portions and configured to fit in a recess in a different cradle portion.

16. The adjustable mobile device holder of claim 15, wherein the one or more tabs are rods and the one or more recesses are openings having a shape and size to receive the rods.

17. The adjustable mobile device holder of claim 15, wherein the one or more tabs are protrusions and the one or more recesses are openings having a shape and size to receive the protrusions.

18. The adjustable mobile device holder of claim 16, wherein a first rod extends from one of the first cradle portion or the second cradle portion into a first recess in the other cradle portion and a second rod extends from one of the first cradle portion or the second cradle portion into a second recess in the other cradle portion.

19. The adjustable mobile device holder of claim 2, wherein the spring is disposed in the second slot forward of the threaded fastener such that the spring is closer to the first cradle portion than the threaded fastener.

20. The adjustable mobile device holder of claim 1, wherein the connector is at least partially disposed in the spring.
